(19) United States
(12) Patent Application Publication
(10) Pub. No.: US 2013/0300875 A1
(43) Pub. Date: Nov. 14, 2013

(54) CORRECTION OF IMAGE DISTORTION IN IR IMAGING

(71) Applicant: Flir Systems AB, Taby (SE)

(72) Inventors: Katrin Strandemar, Rimbo (SE); Henrik Jönsson, Stockholm (SE)

(21) Appl. No.: 13/942,624

(22) Filed: Jul. 15, 2013

Related U.S. Application Data
(63) Continuation-in-part of application No. 13/437,645, filed on Apr. 2, 2012.
Application No. 13/437,645 is a continuation-in-part of application No. 13/105,765, filed on May 11, 2011.
Application No. 13/105,765 is a continuation of application No. PCT/EP2011/056432, filed on Apr. 21, 2011.
Application No. PCT/EP2011/056432 is a continuation of application No. 12/766,739, filed on Apr. 23, 2010, now Pat. No. 8,520,970.
(60) Provisional application No. 61/672,153, filed on Jul. 16, 2012.
(60) Provisional application No. 61/473,207, filed on Apr. 8, 2011.

(51) Int. Cl. H04N 5/217

(52) U.S. Cl. CPC H04N 5/217
USPC 348/164

(57) ABSTRACT

There is disclosed a method, arrangement, and computer program product for correcting distortion present in an image captured using an infrared (IR) arrangement, the method for an embodiment comprising: capturing a first image using a first imaging system comprised in said IR arrangement; and correcting image distortion of the first image based on a pre-determined distortion relationship. According to embodiments, the method may further comprise capturing a second image using a second imaging system comprised in said IR arrangement, wherein: said distortion relationship represents distortion caused by said first and/or second imaging systems of said IR arrangement; and said correcting of image distortion of the first image comprises correcting image distortion with relation to the second image based on said pre-determined distortion relationship, wherein the distortion relationship represents distortion caused by said first and/or second imaging systems.

### CROSS-REFERENCE TO RELATED APPLICATIONS

This patent application claims the benefit of and priority to U.S. Patent Application No. 61/672,153 filed Jul. 16, 2012, which is incorporated herein by reference in its entirety.

This application is a continuation-in-part of U.S. patent application Ser. No. 13/437,645 filed Apr. 2, 2012 and entitled “INFRARED RESOLUTION AND CONTRAST ENHANCEMENT WITH FUSION” which is a continuation-in-part of U.S. patent application Ser. No. 13/105,765 filed May 11, 2011 and entitled “INFRARED RESOLUTION AND CONTRAST ENHANCEMENT WITH FUSION” which is a continuation of International Patent Application No. PCT/EP2011/056432 filed Apr. 21, 2011 and entitled “INFRARED RESOLUTION AND CONTRAST ENHANCEMENT WITH FUSION”, all of which are hereby incorporated by reference in their entirety.

International Patent Application No. PCT/EP2011/056432 claims the benefit of U.S. Provisional Patent Application No. 61/473,207 filed Apr. 8, 2011 and entitled “INFRARED RESOLUTION AND CONTRAST ENHANCEMENT WITH FUSION”, which is hereby incorporated by reference in its entirety.

International Patent Application No. PCT/EP2011/056432 is a continuation of U.S. patent application Ser. No. 12/766,739 filed Apr. 23, 2010 and entitled “INFRARED RESOLUTION AND CONTRAST ENHANCEMENT WITH FUSION”, which is hereby incorporated by reference in its entirety.

### TECHNICAL FIELD

Generally, embodiments of the invention relate to the technical field of correction of infrared (IR) imaging using an IR arrangement.

More specifically, different embodiments of the application relate to correction of distortion in IR imaging, wherein the distortion has been introduced in a captured image, e.g. by physical aspects of at least one imaging system or component, comprised in the IR arrangement, wherein the at least one imaging system being used for capturing the image such as for instance IR images and visual light images.

### BACKGROUND

Production of infrared (IR) or IR arrangements, such as IR cameras, today is often associated with demands of keeping production cost at a minimum.

Since the cost for the optics of the IR or IR arrangements is becoming an increasingly larger part the overall IR imaging device cost, the optics is becoming an area where producers would want to find cheaper solutions. This could for example be achieved by reducing the number of optical elements, such as lenses, included in the optical system, or using inexpensive lenses instead of expensive higher quality lenses.

However, many IR imaging devices today having low cost optical systems also have a short focal length, leading to the introduction of distortion in the IR images captured during use of the IR arrangement. Higher cost lenses may be designed for low distortion, but on the other hand the price of the imaging device will be higher. Furthermore, conventional image processing techniques to correct distortion generally do not address the distortion problems that occur in IR imaging and/or in the context of image fusion of an IR image and a visual light (VL) image.

Accordingly, there still exists a need to achieve distortion correction in an IR arrangement, adapted to the specific issues that arise in such an arrangement. Furthermore, there still exists a need to achieve such a distortion correction in a cost efficient way.

### SUMMARY

Embodiments of the present invention eliminate or at least minimize the problems described above. This is achieved through devices, methods, and arrangements according to the appended claims.

Systems and methods are disclosed, in accordance with one or more embodiments, which are directed to correction of infrared (IR) imaging using an IR arrangement. For example for one or more embodiments, systems and methods may achieve distortion correction in the IR images captured during use of the IR arrangement.

According to one or more embodiments of the invention in the form of systems and methods disclosed herein for correcting distortion present in an image captured using an infrared (IR) arrangement is performed by capturing a first image using a first imaging system comprised in said IR arrangement; and correcting image distortion of the first in said image based on a pre-determined distortion relationship.

According to one or more embodiments, capturing an image comprises capturing a first image using a first imaging system.

According to one or more embodiments, correcting image distortion comprises correcting image distortion in the first image with relation to the observed real world scene based on said pre-determined distortion relationship.

According to one or more embodiments, the said first imaging system is an IR imaging system and the said first image is an IR image captured using said IR imaging system.

According to one or more embodiments, said distortion relationship represents distortion caused by said first imaging system of said IR arrangement in said first image.

According to one or more embodiments, capturing an image comprises capturing a first According to one or more embodiments, capturing a second image using a second imaging system and associating the first and second image.

According to one or more embodiments, said first image captured using a first imaging system is an IR image captured using an IR imaging system and said second image captured using a second imaging system is a visual light (VL) image captured using a VL imaging system.

According to one or more embodiments, correcting image distortion comprises to correct image distortion in the first image with relation to the second image based on said pre-determined distortion relationship.

According to one or more embodiments, said distortion relationship represents distortion caused by said first imaging system in said first image, distortion caused by said second imaging system in said second image and a relation between distortion caused by said first imaging system in said first image and the distortion caused by said second imaging system in said second image.

According to one or more embodiments, the method further comprises capturing a second image using a second imaging system comprised in said IR arrangement, wherein: said distortion relationship represents distortion caused by said first and/or second imaging systems of said IR arrangement; and said correcting of image distortion of the first image comprises correcting image distortion with relation to the second image based on said pre-determined distortion relationship.

According to one or more embodiments, the method further comprises correcting image distortion of the second image with relation to the first image based on said pre-determined distortion relationship.

According to one or more embodiments, the first imaging system is an IR imaging system, whereby the first image is an IR image, and the second imaging system is a visible light imaging system, whereby the second image is a visible light image; the first imaging system is a visible light imaging system whereby the first image is a visible light image and the second imaging system an IR imaging system whereby the second image is an IR image; the first and the second imaging systems are two different IR imaging systems and the first and second images are IR images captured using the first and second IR imaging system respectively; or the first and the second imaging systems are two different visible light imaging systems and the first and the second images are visible light images captured using first and second visible light imaging system respectively.

According to one or more embodiments, the first imaging system is an IR imaging system whereby the first image is an IR image and the second imaging system is a visible light imaging system whereby the second image is a visible light image; the first imaging system is a visible light imaging system whereby the first image is a visible light image and the second imaging system an IR imaging system whereby the second image is an IR image; the first and the second imaging systems are two different IR imaging systems and the first and second images are IR images captured using the first and second IR imaging system respectively; or the first and the second imaging systems are two different visible light imaging systems and the first and the second images are visible light images captured using first and second visible light imaging system respectively.

According to one or more embodiments, said pre-determined distortion relationship is represented in the form of a distortion map or a look up table.

According to one or more embodiments, the distortion map or look up table is based on one or more models for distortion behavior.

According to one or more embodiments, said correction of distortion comprises mapping of pixel coordinates of an input image to pixel coordinates to a corrected output image in the x-direction and in the y-direction, respectively.

According to one or more embodiments, the calculated distortion relationship is at least partly dependent on distortion in the form of rotational and/or translational deviations.

According to one or more embodiments, the method further comprises combining said first and second image into a combined image.

According to one or more embodiments, the combined image is a contrast enhanced version of the IR image with addition of VL image data.

According to one or more embodiments, the method further comprises obtaining the combined image by aligning the IR image and the VL image, determining that the VL image resolution value and the IR image resolution value are substantially the same, and combining the IR image and the VL image.

According to one or more embodiments, said combining said first and second image further comprises processing the VL image by extracting high spatial frequency content of the VL image.

According to one or more embodiments, said combining said first and second image further comprises processing the IR image to reduce noise in and/or blur the IR image.

According to one or more embodiments, said combining said first and second image further comprises adding high resolution noise to the combined image.

According to one or more embodiments, said combining said first and second image further comprises combining the extracted high spatial frequency content of the captured VL image and the IR image to a combined image.

According to one or more embodiments, the method further comprises communicating data comprising the associated images to an external unit via a data communication interface.

According to one or more embodiments, the method further comprises displaying the associated images on a display integrated in or coupled to the thermography arrangement.

According to one or more embodiments, the method may be implemented in hardware, e.g. in an FPGA. According to method embodiments, a distortion correction map may be pre-determined and placed in a look-up-table (LUT). By using the LUT and interpolation of pixel values, the complexity of the hardware design may be reduced without significant loss of precision compared to calculating values at run-time.

According to an embodiment, there is provided an infrared (IR) arrangement for capturing an image and for correcting distortion present in said image, the arrangement comprising: at least one IR imaging system for capturing an IR image and/or at least one visible light imaging system for capturing a visible light image; a memory for storing a pre-determined distortion function representing distortion caused by one or more imaging systems, of said IR arrangement; and a processing unit configured to receive of retrieve said pre-determined distortion relationship from said memory during operation of said IR arrangement, wherein the processing unit is further configured to use said pre-determined distortion relationship to correct distortion of said captured one or more images during operation of said IR arrangement, the processor further configured to: capture an image using an imaging system comprised in said IR arrangement, and correct image distortion in said image based on a pre-determined distortion relationship.

According to one or more embodiments, the processing unit is adapted to perform all or part of the various methods disclosed herein.

An advantageous effect obtained by embodiments described herein is that the optical systems for the IR arrangement or IR camera used can be made at a lower cost, since some distortion is allowed to occur. Typically, fewer lens elements can be used which greatly reduces the production cost. Embodiments of the invention may also greatly improve the output result using a single-lens solution. According to embodiments wherein the number of optical elements is reduced, high image quality is instead obtained through image processing according to embodiments described herein; either during operation of an IR arrangement or IR camera, or in post-processing of images captured using such an IR arrangement or IR camera. Thereby, further advantageous effects of embodiments disclosed herein are that the cost for optics included in the imaging systems, particularly IR imaging systems, may be reduced while the output image quality is maintained or enhanced, or alternatively that the image quality is enhanced without increase of the optics cost.

A specific problem that arises in IR imaging involving combining images, for example fusion, of images captured using different imaging systems, for example an IR imaging system and a visible light imaging system, is that the images must be aligned in order for the combination result to be satisfying for visual interpretation and measurement correlation. The inventors have realized that by reducing the computational complexity by leaving out the step of performing distortion correction with respect to the imaged scene or an external reference, and instead performing distortion correction of the images in relation to each other according to the different embodiments presented herein, the distortion correction can be performed in a much more resource-efficient way, with satisfying output quality. In other words, the distortion correction according to embodiments described herein further does not have to be “perfect” with respect to the imaged scene or to an external reference. Therefore, the distortion correction is performed in a cost and resource efficient way compared to previous more computationally expensive solution.

A further advantageous effect achieved by embodiments of the invention is that an improved alignment of images to be combined is achieved, thereby also rendering higher quality images, e.g. sharper images, after combination.

Furthermore, since the calculations involved are not computationally expensive, embodiments of the invention may be performed in real time, during operation of the IR arrangement. Furthermore, embodiments of the invention may be performed using an FPGA or other type of limited or functionally specialized processing unit.

Typically, IR images have a lower resolution than visible light images and calculation of distortion corrected pixel values is hence less computationally expensive than for visible light images. Therefore, it may be advantageous to distortion correct IR images with respect to visible light images. However, depending on the imaging systems used, the opposite may be true for some embodiments. Furthermore, since IR images are typically more “blurry,” or in other words comprise less contrast in the form of contour and outlines for example, than visible light images, down-sampling and use of interpolated values may be used for IR images without any visible degradation occurring. As presented herein, embodiments of the invention, wherein images from two different imaging systems are referred to, may also relate to partly correcting both the first and the second image with respect to the other.

Any suitable interpolation method known in the art may be used for the interpolation according to embodiments of the invention, dependent on circumstances such as for instance if the focus is on quality or computational cost.

As described herein, embodiments of methods and arrangements further solve the problem of correcting distortion in the form of rotation and/or translation caused by the respective imaging systems comprised in the IR arrangement.

According to embodiments, there is provided a computer system having a processor being adapted to perform all or part of the various embodiments of the methods disclosed herein.

According to embodiments, there is provided a computer-readable medium on which is stored non-transitory information adapted to control a processor to perform all or part of the various embodiments of the methods disclosed herein.

The scope of the invention is defined by the claims, which are incorporated into this Summary by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF DRAWINGS

Embodiments of the invention will now be described in more detail with reference to the appended drawings, wherein:

FIG. 1 is a schematic view of an infrared (IR) arrangement according to embodiments of the invention.

FIGS. 2a and 2b show examples of image distortion correction according to embodiments.

FIGS. 3a and 3b show flow diagrams of distortion correction methods according to embodiments.

FIG. 4 shows a flow view of distortion correction according to embodiments.

FIG. 5 is a flow diagram of methods according to embodiments.

FIG. 6 shows a flow diagram of a method to obtain a combined image from an IR image and a visual light (VL) image in accordance with an embodiment of the disclosure.

FIG. 7 shows an example of an input device comprising an interactive display such as a touch screen, an image display section, and controls enabling the user to enter input, in accordance with an embodiment of the disclosure.

FIG. 8a illustrates example field-of-views (FOVs) of a VL imaging system and an IR imaging system without a FOV follow functionality enabled in accordance with an embodiment of the disclosure.

FIG. 8b illustrates an example of a processed VL image and a processed IR image depicting or representing substantially the same subset of a captured view when a FOV follow functionality is enabled in accordance with an embodiment of the disclosure.

FIG. 9 shows an example display comprising display electronics to display image data and information including IR images, VL images, or combined images of associated IR image data and VL image data, in accordance with an embodiment of the disclosure.

FIG. 10a illustrates a method of combining a first distorted image and a second distorted image without distortion correction in accordance with an embodiment of the disclosure.

FIG. 10b illustrates a method of combining a first distorted image and a second distorted image with a distortion correction functionality enabled in accordance with an embodiment of the disclosure.

Embodiments of the invention and their advantages are best understood by referring to the detailed description that follows. It should be appreciated that like reference numerals are used to identify like elements illustrated in one or more of the figures.

### DETAILED DESCRIPTION

### Introduction

Below, embodiments of methods, IR arrangements, IR cameras and computer-readable mediums for distortion correction are presented.

### Image Distortion (Also Referred to as Distortion)

When capturing an image by an imaging system various errors or deviations in the form of images distortions or distortions might occur, e.g. resulting in distortion of the shape of an object in an observer real world scene in relation to the representation of the same object captured in an image. As an example, straight lines in a scene do not remain straight in an image. Various types of image distortion exists, such as, but not limited to, barrel distortion, pincushion distortion, mustache or complex image distortion, parallax pointing error, parallax distance error, resolution error or parallax rotational error.

Image distortion might also relate to difference in the representation of an object in an observed real world scene between a first image captured by a first imaging system and a second image captured by a second imaging system.

Due to the fact that a first imaging system might be rotated around its first optical axis differently than how a second imaging system is rotated around its second optical axis, a rotational distortion might occur, e.g. of the angle α is introduced, also referred to as parallax rotational error, radial distortion or rotational distortion/deviation which might be used in this text interchangeably. As every imaging system has a field of view (FOV), which is the extent of the observable world that is seen at any given moment, the FOV of a first and a second imaging system might differ. Due to the fact that a first imaging system might be positioned so that its first optical axis is translated, e.g. mounted with some distance apart, in relation to a second imaging systems second optical axis, a translational image distortion is introduced, also referred to as parallax distance error which might be used in this text interchangeably. Due to the fact that a first imaging system might be positioned so that its first optical axis is not parallel to a second imaging systems second optical axis, a pointing error image distortion might be introduced, also referred to as parallax pointing error which might be used in this text interchangeably.

As the pixel resolution value, i.e. the number of elements in the image sensor, of the first imaging system and the pixel resolution value of a second imaging system might differ, which results in yet another form of image distortion, in relation between the first and second captured image, also referred to as resolution error.

### System Architecture

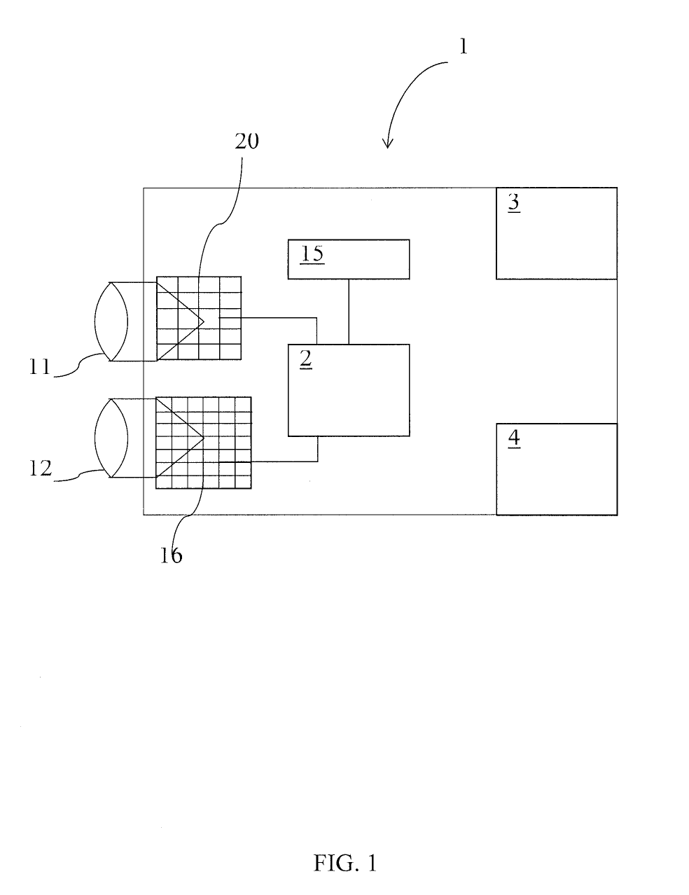

FIG. 1 shows a schematic view of an embodiment of an IR arrangement/IR camera or thermography arrangement 1 that comprises one or more infrared (IR) imaging system 11, each having an IR sensor 20, e.g., any type of multi-pixel infrared detector, such as a focal plane array, for capturing infrared image data, e.g. still image data and/or video data, representative of an imaged observed real world scene. In one or more embodiments, the one or more infrared sensors 20 of the one or more IR imaging systems 11 provide for representing, e.g. converting, the captured image data as digital data, e.g., via an analog-to-digital converter included as part of the IR sensor 20 or separate from the IR sensor 20 as part of the IR arrangement 1.

According to embodiments, the IR arrangement 1 may further comprise one or more visible/visual light (VL) imaging system 12, each having a visual light (VL) sensor 16, e.g., any type of multi-pixel visual light detector for capturing visual light image data, e.g. still image data and/or video data, representative of an imaged observed real world scene. In one or more embodiments, the one or more visual light sensors 16 of the one or more VL imaging systems 12 provide for representing, e.g. converting, the captured image data as digital data, e.g., via an analog-to-digital converter included as part of the IR sensor 20 or separate from the VL sensor 16 as part of the IR arrangement 1.

For the purpose of illustration, an arrangement comprising one IR imaging system 11 and one visible light (VL) imaging system 12 is shown in FIG. 1.

In one or more embodiments the IR arrangement 1 may represent an IR imaging device, such as an IR camera, to capture and process images, such as consecutive image frame, or video image frames, of a real world scene.

In one or more embodiments, the IR arrangement 1 may comprise any type of IR camera or IR imaging system configured to detect IR radiation and provide representative data and information, for example infrared image data of a scene or temperature related infrared image data of a scene, represented as different color values, grey scale values of any other suitable representation that provide a visually interpretable image.

In an exemplary embodiment, the arrangement 1 may represent an IR camera that is directed to the near, middle, and/or far infrared spectra.

In one or more embodiments, the arrangement 1, or IR camera, may further comprise a visible light (VL) camera or VL imaging system adapted to detect visible light radiation and provide representative data and information, for example as visible light image data of a scene. In one or more embodiments, the arrangement 1, or IR camera, may comprise a portable, or handheld, device.

Hereinafter, the term IR arrangement may refer to a system of physically separate but coupled units, an IR imaging device or camera wherein all the units are integrated, or a system or device wherein some of the units described below are integrated into one device and the remaining units are coupled to the integrated device or configured for data transfer to and from the integrated device.

According to embodiments, the IR arrangement 1 further comprises at least one memory 15, or is communicatively coupled to at least one external memory (not shown in the figure).

In one or more embodiments, the IR arrangement may according to embodiments comprise a control component 3 and/or a display 4/display component 4.

In one or more embodiments, the control component 3 comprises a user input and/or interface device, such as a rotatable knob, e.g. a potentiometer, push buttons, slide bar, keyboard, soft buttons, touch functionality, an interactive display, joystick and/or record/push-buttons. In one or more embodiments, the control component 3 is adapted to generate a user input control signal.

In one or more embodiments, in response to input commands and/or user input control signals, the processor 2 controls functions of the different parts of the thermography arrangement 1

In one or more embodiments, the processing unit 2, or an external processing unit, may be adapted to sense control input signals from a user via the control component 3 and respond to any sensed user input control signals received therefrom.

In one or more embodiments, the processing unit 2, or an external processing unit, may be adapted to interpret such a user input control signal as a value according to one or more ways as would be understood by one skilled in the art.

In one embodiment, the control component 3 may comprise a user input control unit, e.g., a wired or wireless handheld control unit having user input components, such as push buttons, soft buttons or other suitable user input enabling components adapted to interface with a user and receive user input, determine user input control values and send a control unit signal to the control component triggering the control component to generate a user input control signal.

In one or more embodiments, the user input components of the control unit comprised in the control component 3 may be used to control various functions of the IR arrangement 1, such as autofocus, menu enablement and selection, field of view (FOV) follow functionality, level, span, noise filtering, high pass filtering, low pass filtering, fusion, temperature measurement functions, distortion correction settings, rotation correction settings and/or various other features as understood by one skilled in the art.

In one or more embodiments, one or more of the user input components may be used to provide user input values, e.g. adjustment parameters such as the desired percentage of pixels selected as comprising edge information, characteristics, etc., for an image stabilization algorithm.

In an exemplary embodiment, one or more user input components may be used to adjust low pass and/or high pass filtering characteristics of, and/or threshold values for edge detection in, infrared images captured and/or processed by the IR arrangement 1.

According to an embodiment, a “FOV follow” functionality or in other words matching of the FOV of IR images with the FOV of corresponding VL images is a mode that may be turned on and off. Turning the FOV follow mode on and off may be performed automatically, based on settings of the thermography arrangement, or manually by a user interacting with one or more of the input devices.

In one or more embodiments at least one of the first and second images, e.g. a visible light image and/or the IR image, is processed such that the field of view represented in the visible light image substantially corresponds to the field of view represented in the IR image. In one or more embodiments processing at least one of the first and second images comprises a selection of the following operations: cropping; windowing; zooming; shifting; and rotation of at least one of the images or parts of at least one of the images.

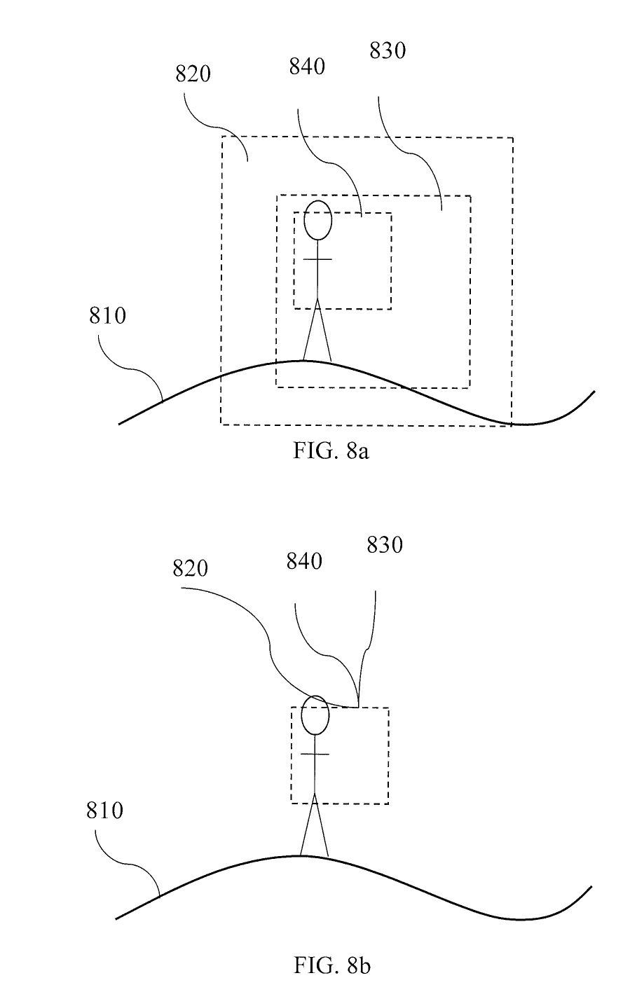

FIG. 8a shows examples of how the captured view without FOV functionality is for a VL imaging system 820 and how the captured view without FOV functionality is for an IR imaging system 830. FIG. 8a also shows an exemplary subset 840 of the captured view of the real world scene entirely enclosed by the IR imaging system FOV and the VL imaging system FOV. In addition FIG. 8a shows an observed real world scene 810.

FIG. 8b shows an example how, when FOV functionality is activated, the processed first image, e.g. an IR image the processed second image, e.g. a visible light image (VL), depicts or represents substantially the same subset of the captured view

In one or more embodiments, the display component 4 comprises an image display device, e.g., a liquid crystal display (LCD), or various other types of known video displays or monitors. The processing unit 2, or an external processing unit, may be adapted to display image data and information on the display 4. The processing unit 2, or an external processing unit, may be adapted to retrieve image data and information from the memory unit 15, or an external memory component, and display any retrieved image data and information on the display 4.

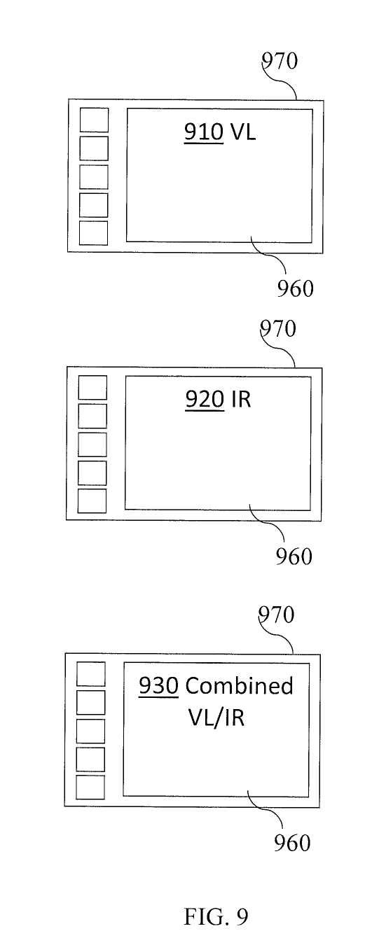

In one or more embodiments, the display 4 may comprise display electronics, which may be utilized by the processing unit 2, or an external processing unit, to display image data and information, for example infrared (IR) images, visible light (VL) images or combined images of associated infrared (IR) image data and visible light (VL) image data, for instance in the form of combined image, such as fused, blended or picture in picture images. An exemplary embodiment is shown in FIG. 9.

In one or more embodiments, the display component 4 may be adapted to receive image data and information directly from the imaging systems 11, 12 via the processing unit 2, or an external processing unit, or the image data and information may be transferred from the memory 15, or an external memory component, via the processing unit 2, or an external processing unit.

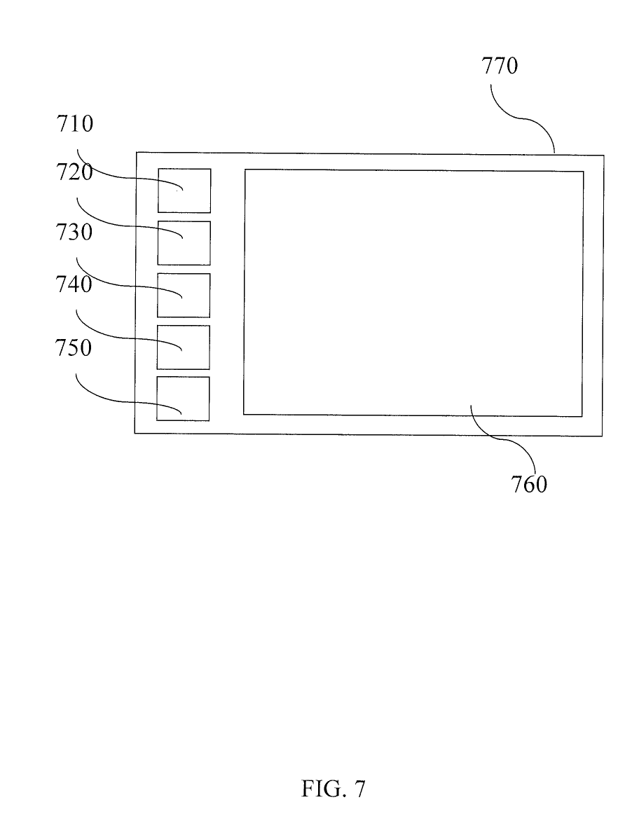

In FIG. 7 an exemplary embodiment of a control component 3 comprising a user input control unit having user input components is shown. The control component 3 comprises an interactive display 770, such as a touch screen, an image display section 760 and input components 710-750 enabling the user to enter input.

According to an embodiment, the input device comprises controls enabling the user to perform the functions of:

Selecting the distortion correction target mode 710, such as correcting distortion with regard to an observed real world scene or with regard to alignment of a first and a second image with regard to each other.

Selecting the distortion correction operating mode 720 of distortion correction based on a distortion relationship, such as correcting distortion of a first image, correcting distortion of a second image, correcting distortion of a first image based on the second image or correcting distortion of a second image based on a first image.

Activate 730 or deactivate the “FOV follow” functionality, i.e. matching of the FOV represented by the associated IR images with the FOV of the associated VL image.

Selecting 740 to access/or display an image, such as an associated IR image, an associated VL image or a combined image based on the associated IR image and the associated VL image. This is further detailed in FIG. 9, showing an interactive display 970 (implemented in a similar manner as display 770) and an image display section 960 (implemented in a similar manner as image display section 760) displaying a VL image 910, an IR image 920, or combined VL/IR image 930 depending on the selecting 740.

Storing or saving images 750 to a memory 15 or retrieving images from a memory

According to different embodiments, all parts of the IR arrangement 1, as described herein, may be comprised in, external to but communicatively coupled to or integrated in a thermography arrangement/device, such as for instance an IR camera.

In one or more embodiments, the capturing of IR images is performed by the at least one IR imaging system 11 comprised in the IR arrangement 1.

In one or more embodiments, also visual images are captured by at least one visible light imaging system 12 comprised in the IR arrangement 1.

In one or more embodiments, the captured one or more images may be transmitted/sent to a processing unit 2, comprised in the IR arrangement 1, configured to perform image processing operations.

In one or more embodiments, the captured images may also be transmitted directly or with intermediate storing to a processing unit separate or external from the imaging device (not shown in the figure).

In one or more embodiments, the processing unit 2 in the IR arrangement 1 or the separate processing unit may be provided with or comprising specifically designed programming sections of code or code portions adapted to control the processing unit to perform the steps and functions of embodiments of the inventive method described herein.

In one or more embodiments, the processing unit 2 and/or external processing unit may be a processor such as a general or special purpose processing engine for example a microprocessor, microcontroller or other control logic that comprises sections of code or code portions adapted to control the processing unit and/or external processing unit to perform the steps and functions of embodiments of the inventive method described herein, wherein said sections of code or code portions are stored on a computer readable storage medium.

In one or more embodiments, said sections of code are fixed to perform certain tasks/functions. In one or more embodiments, said sections of code are other sections of alterable sections of code, stored on a computer readable storage medium that can be altered during use.

In one or more embodiments, said alterable sections of code can comprise parameters that are to be used as input for the various tasks/functions of the processing unit 2 and/or external processing unit, such as the calibration of the IR arrangement 1, the sample rate or the filter for the spatial filtering of the images, the operation mode of distortion correction, the distortion relationship, or any other IR arrangement function as would be understood by one skilled in the art.

In one or more embodiments more than one processing unit may be integrated in, coupled to or configured for transfer of data to or from the IR arrangement 1.

In one or more embodiments, the processing unit 2 and/or an external processing unit is configured to process infrared image data from the one or more infrared (IR) sensor 20 depicting an observed real world scene.

In one or more embodiments the processing unit 2 and/or the external processing unit is configured to perform any or all of the method steps or functions disclosed herein.

In one or more embodiments there is provided an infrared (IR) arrangement 1 configured to capturing an image and to correcting distortion present in said image, wherein the arrangement comprises: a first imaging system configured to capture a first image; a memory, 15 or 8, configured to store a pre-determined distortion relationship, e.g. a pre-determined function, representing distortion caused by said first imaging system of said IR arrangement in said first image; and a processing unit 2 configured to receive or retrieve said pre-determined distortion relationship from said memory during operation of said IR arrangement, wherein the processing unit is further configured to use said pre-determined distortion relationship to correct distortion of said captured first image during operation of the IR arrangement.

In one or more embodiments, said pre-determined distortion relationship is pre-calculated and stored in memory.

In one or more embodiments, said pre-determined distortion relationship is dynamically calculated by said processing unit 2 and stored in memory 15 at pre-determined intervals.

In an exemplary embodiment, the pre-determined distortion relationship is dynamically calculated at start-up of the IR arrangement 1, when a parameter stored in memory compared to an image related measurement exceeds a pre-determined threshold or prior to each distortion correction.

According to an embodiment, the pre-determined distortion relationship represents distortion caused by the first imaging system of said IR arrangement in said first image.

According to an embodiment, the infrared (IR) arrangement 1 may comprise an IR camera, and one or more of the first imaging system, the memory and the processing units, and are integrated into said IR camera.

According to an embodiment, the first imaging system is an IR imaging system and the first image is an IR image captured using said IR imaging system.

According to an embodiment, the IR arrangement further comprises a second imaging system configured to capture a second image.

In one or more embodiments, said distortion relationship represents distortion caused by said first and/or second imaging systems of said IR arrangement; and said processing unit is configured to correct said image distortion of the first image by correcting image distortion with relation to the second image based on said pre-determined distortion relationship.

In one or more embodiments, said pre-determined distortion relationship represents distortion caused by said first imaging system in said first image, distortion caused by said second imaging system in said second image, a relation between distortion caused by said first imaging system in said first image and the distortion caused by said second imaging system in said second image; and said processing unit 2 is configured to correct image distortion based on said pre-determined distortion relationship.

In one or more embodiments, said processing unit 2 is configured to correct image distortion in the first image with relation to the observed real world scene based on said pre-determined distortion relationship. In one or more embodiments, said processing unit 2 is configured to correct image distortion in the first image with relation to the second image based on said pre-determined distortion relationship. In one or more embodiments, said processing unit 2 is configured to correct image distortion in the second image with relation to the observed real world scene based on said pre-determined distortion relationship. In one or more embodiments, said processing unit 2 is configured to correct image distortion in the second image with relation to the first image based on said pre-determined distortion relationship.

In one or more embodiments, said relation between distortion caused by said first imaging system in said first image and the distortion caused by said second imaging system in said second image is represented by a difference in distortion between said first imaging system and a said second imaging system.

In one or more embodiments, said relation between distortion caused by said first imaging system in said first image and the distortion caused by said second imaging system in said second image is represented by a difference in distortion between an IR imaging system and a visible light imaging system, both comprised in an IR arrangement 1.

In one or more embodiments, said relation between distortion caused by said first imaging system in said first image and the distortion caused by said second imaging system in said second image is represented by the parallax error between said first and said second imaging systems of said IR arrangement describing the difference in field of view (FOV) or the difference in view of the captured observed real world scene by the first imaging system and said second imaging system.

According to an embodiment, the processing unit 2, or external processing unit, is further configured to correct image distortion of the second image with relation to the first image based on said pre-determined distortion relationship.

According to an embodiment, the processing unit 2, or external processing unit, is configurable using a hardware description language (HDL).

According to an embodiment, the processing unit 2 and/or the external processing unit is a Field-programmable gate array (FPGA), i.e. an integrated circuit designed to be configurable by the customer or designer after manufacturing and configurable using a hardware description language (HDL). For this purpose embodiments of the invention comprise configuration data configured to control an FPGA to perform the steps and functions of the method embodiments described herein.

In various embodiments, the processing unit 2 and/or an external processing unit comprises a processor, such as one or more of a microprocessor, a single-core processor, a multi-core processor, a microcontroller, a logic device, e.g., a programmable logic device (PLD) configured to perform processing functions, a digital signal processing (DSP) device, a graphics processing unit (GPU), an application-specific integrated circuit (ASIC) etc.

In one or more embodiments, implementation of some or all of the steps of the distortion correction method, or algorithm, in an FPGA is enabled since the method, or algorithm, comprises no complex or computationally expensive operations.

In this document, the terms “computer program product” and “computer-readable storage medium” may be used generally to refer to media such as a memory 15/8 or the storage medium of processing unit 2 or an external storage medium.

These and other forms of computer-readable storage media may be used to provide instructions to processing unit 2 for execution. Such instructions, generally referred to as “computer program code” (which may be grouped in the form of computer programs or other groupings), when executed, enable the IR arrangement 1 to perform features or functions of embodiments of the current technology. Further, as used herein, “logic” may include hardware, software, firmware, or a combination of thereof.

In one or more embodiments, the processing unit 2 and/or the external processing unit is communicatively coupled to and communicates with a memory 15 and/or an external memory 8 where parameters are kept ready for use by the processing unit 2 and/or the external processing unit, and where the images being processed by the processing unit 2 can be stored if the user desires.

In one or more embodiments, the one or more memories 15 may comprise a selection of a hard disk drive, a floppy disk drive, a magnetic tape drive, an optical disk drive, a CD or DVD drive (R or RW), or other removable or fixed media drive.

According to embodiments, the processing unit 2 and/or the external processing unit may be adapted to interface and communicate with the other components of the IR arrangement 1 to perform method and processing steps and/or operations, as described herein.

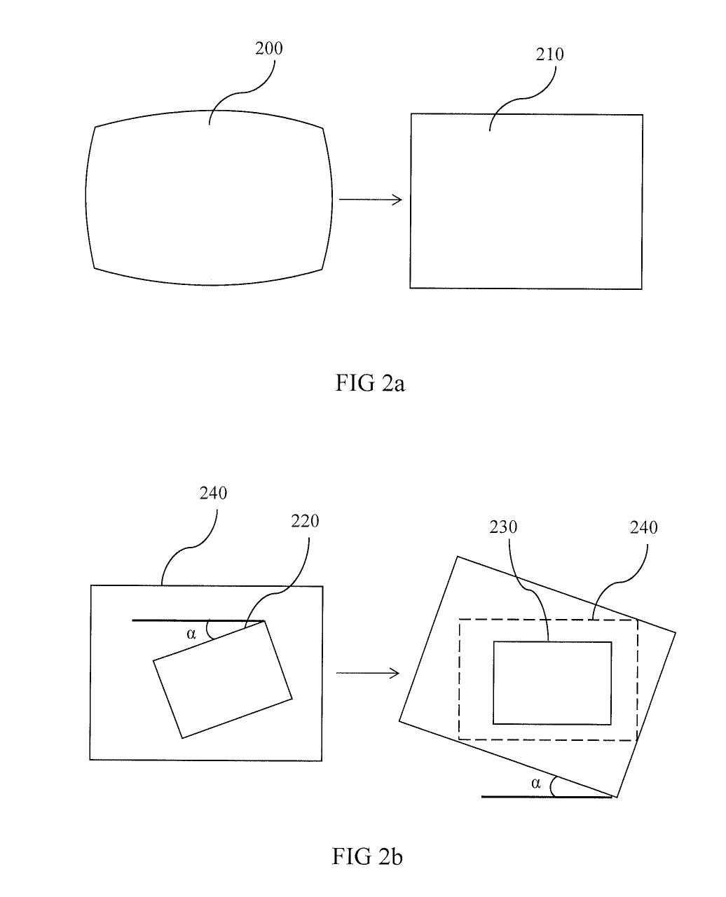

In one or more embodiments, the processing unit 2 and/or the external processing unit may include a distortion correction module (not shown in the figures) adapted to implement an distortion correction method, or algorithm, for example a distortion correction method or algorithm such as discussed in reference to FIGS. 2-4.

In one or more embodiments, the processing unit 2 and/or the external processing unit may be adapted to perform various other image processing operations including translation/shifting or images, rotation of images and comparison of images or other data collections that may be translated and/or rotated, either as part of or separate from the distortion correction method embodiments.

In one or more embodiments, the distortion correction module may be integrated in software and/or hardware as part of the processing unit 2 and/or the external processing unit, with code, e.g. software, firmware or configuration data, for the distortion correction module stored, for example in the memory 15 and/or an external and accessible memory.

In one or more embodiments, the distortion correction method, as disclosed herein, may be stored by a separate computer-readable medium, for example a memory, such as a hard drive, a compact disk, a digital video disk, or a flash memory, to be executed by a computer, e.g., a logic or processor-based system, to perform various methods and operations disclosed herein.

In one or more embodiments, the computer-readable medium may be portable and/or located separate from the arrangement 1, with the stored distortion correction method, algorithm, map or LUT, provided to the arrangement 1 by coupling the computer-readable medium to the arrangement 1 and/or by the arrangement 1 downloading, e.g. via a wired link and/or a wireless link, the distortion correction method, algorithm, map or LUT from the computer-readable medium.

In one or more embodiments, the memory 15, or an external memory unit, comprises one or more memory devices adapted to store data and information, including infrared data and information. In one or more embodiments, the memory 15, or an external memory unit, may comprise one or more various types of memory devices including volatile and non-volatile memory devices, such as RAM (Random Access Memory), ROM (Read-Only Memory), EEPROM (Electrically-Erasable Read-Only Memory), flash memory, etc.

In one or more embodiments, the processing unit 2, or an external processing unit, may be adapted to execute software stored in the memory 15, or an external memory unit, so as to perform method and process steps and/or operations described herein.

In various embodiments, components of the IR arrangement 1 may be combined and/or implemented or not, as desired or depending on the application or requirements, with the arrangement 1 representing various functional blocks of a related system. In one exemplary embodiment, the processing unit 2 may be combined with the memory component 15, the imaging systems 11, 12 and/or the display 4.

In another exemplary embodiment, the processing unit 2 may be combined one of the with the imaging systems 11, 12 with only certain functions of the processing unit 2 performed by circuitry, e.g., a processor, a microprocessor, a logic device, a microcontroller, etc., within said one of the imaging systems 11, 12.

In one or more embodiments, various components of the IR arrangement 11 may be remote from each other, e.g. one or more of the imaging systems 11, 12 may comprise a remote sensor with processing unit 2, or an external processing unit, etc. representing a computer that may or may not be in communication with the one or more imaging systems 11, 12.

### METHOD EMBODIMENTS

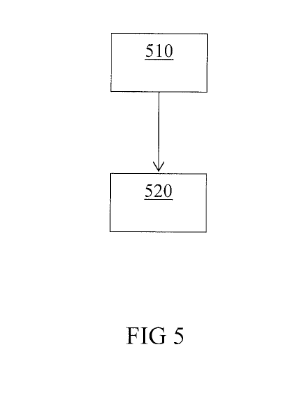

In FIG. 5, method embodiments for correcting distortion, also referred to as image distortion, present in an image captured using an infrared (IR) arrangement are shown as a flow diagram, the method comprising:

In step 510: capturing a first image using an first imaging system comprised in said IR arrangement; and

In step 520: correcting image distortion of the first image based on a pre-determined image distortion relationship.

In one or more embodiments, the pre-determined image distortion relationship is represented in the form of an distortion map or a look up table (LUT).

In one or more embodiments, the distortion map or look up table is based on one or more models for distortion behavior types, such as barrel distortion, pincushion distortion or mustache/complex distortion, per se known in the art as would be understood by a person skilled in the art)

In one or more embodiments, the exemplified distortion types represent radial distortion that lead to e.g. distortion of straight lines into different kinds of non-straight lines.

According to an embodiment, the correction of distortion comprises mapping of pixel coordinates of an input image to pixel coordinates of a corrected output image in the x-direction and in the y-direction, respectively.

According to an embodiment, the pre-determined image distortion relationship is a calculated image distortion relationship that is at least partly dependent on image distortion in the form of rotational and/or translational deviations that indicates a one-to-one relationship between the pixel coordinates of the input image 300 and the pixel coordinates of the corrected output image

According to an embodiment, the first imaging system is an IR imaging system and the first image is an IR image captured using said IR imaging system.

According to an embodiment, said image distortion relationship represents image distortion in said first image caused by said first imaging system of said IR arrangement.

According to embodiments, step 510 may further comprise capturing a second image using a second imaging system comprised in said IR arrangement, wherein: said image distortion relationship represents image distortion caused by said first and/or second imaging systems of said IR arrangement; and said correcting image distortion of the first image comprises correcting image distortion with relation to the second image based on said pre-determined image distortion relationship.

According to an embodiment, the method further comprises correcting image distortion of the second image with relation to the first image based on said pre-determined image distortion relationship.

In an alternative embodiment, a method for correcting image distortion present in an image captured using an infrared (IR) arrangement 1, the method comprising:

In step 510: capturing an image using an imaging system comprised in said IR arrangement; and

In step 520: correcting image distortion of said image based on an image distortion relationship.

In one or more embodiments, where capturing an image in step 510 comprises capturing a first image using a first imaging system.

In one or more embodiments, wherein said first image captured using a first imaging system is an IR image captured and said first imaging system is an IR imaging system.

In one or more embodiments, where said first image captured using a first imaging system is a visual light (VL) image captured and said first imaging system is a VL imaging system.

In one or more embodiments, where capturing an image further comprises capturing a second image using a second imaging system.

In one or more embodiments, where said second image captured using a second imaging system is an IR image captured and said second imaging system is an IR imaging system.

In one or more embodiments, where said second image captured using a second imaging system is a visual light (VL) image captured and said second imaging system is a VL imaging system.

In one or more embodiments, where capturing an image further associating the first and second image.

In one example the association is obtained by generating a common data structure wherein said first and second image is stored.

In one non limiting example the step of capturing an image using an imaging system comprised in said IR arrangement is one of: capturing an IR image using a first imaging system; capturing an VL image using a first imaging system; capturing an IR image using a first imaging system and capturing a VL image using a second imaging system; capturing a VL image using a first imaging system and capturing an IR image using a second imaging system; capturing an IR image using a first imaging system and capturing an IR image using a second imaging system; or capturing a VL image using a first imaging system and capturing a VL image using a second imaging system.

### Correcting Image Distortion

In one or more embodiments, correcting image distortion (e.g., in step 520) comprises correcting image distortion in the first image with relation to the observed real world scene based on said pre-determined image distortion relationship.

In one non limiting example, said pre-determined image distortion relationship could be obtained at the time of design or production of said infrared (IR) arrangement 1. This could be obtained by capturing images of an object in said observed real world scene, such as a flat surface configured with a grid pattern, analyzing the image distortion in said captured image with relation to said observed real world scene and determine the required correction values to correct, minimize or reduce image distortion in the first image with relation to the observed real world scene and store said correction values as a pre-determined image distortion relationship. Said pre-determined image distortion relationship might be determined for a limited set of distances between said IR arrangement 1 and said observed real world scene.

In one or more embodiments, said correcting image distortion comprises correcting image distortion in the first image with relation to the second image based on said pre-determined image distortion relationship.

In one non limiting example, said pre-determined image distortion relationship could be obtained at the time of design or production of said infrared (IR) arrangement 1. This could be obtained by capturing a first and a second image of an object in said observed real world scene, such as a flat surface configured with a grid pattern, analyzing the image distortion in said first captured image with relation to said captured second image and determine the required correction values to correct, minimize or reduce image distortion in the first image with relation to second image and store said correction values as a pre-determined image distortion relationship. Said pre-determined image distortion relationship might be determined for a limited set of distances between said IR arrangement 1 and said observed real world scene.

In one or more embodiments, said correcting comprises correcting image distortion in the second image with relation to the observed real world scene based on said pre-determined image distortion relationship.

In one or more embodiments, said correcting comprises correcting image distortion in the second image with relation to the first image based on said pre-determined image distortion relationship.

In one or more embodiments, said image distortion relationship comprises: image distortion caused by said first imaging system in said first image; image distortion caused by said second imaging system in said second image; and a relation between image distortion caused by said first imaging system in said first image and the image distortion caused by said second imaging system in said second image.

In one or more embodiments, said relation between image distortion caused by said first imaging system in said first image and the image distortion caused by said second imaging system in said second image comprises a difference in image distortion between said first imaging system and a said second imaging system.

In one or more embodiments, said relation between image distortion caused by said first imaging system in said first image and the image distortion caused by said second imaging system in said second image comprises a difference in image distortion between an IR imaging system and a visible light (VL) imaging system.

In one or more embodiments, said relation between image distortion caused by said first imaging system in said first image and the image distortion caused by said second imaging system in said second image further comprises: parallax distance error between said first and said second imaging systems of said IR arrangement, wherein the parallax distance error describes translational image distortion dependent on the translation of the optical axes of the first imaging system in relation to said second imaging systems optical axis; parallax pointing error, wherein the pointing error image distortion describes deviation from parallel orientation of said first optical axis to a second imaging systems second optical axis; parallax rotational error, radial distortion or rotational distortion/deviation, wherein the parallax rotational error describes rotation image distortion of said first imaging system around its first optical axis in relation to rotation of said second imaging system around its second optical axis; and pixel resolution value error, wherein the pixel resolution value error image distortion describes pixel resolution image distortion dependent on the pixel resolution value (i.e. number of elements in the image sensor) of the first imaging system and the pixel resolution value of the second imaging system.

In one or more embodiments a first and a second image have been captured in step 510, the method may further comprise combining said first and second image into a combined image, for example by performing fusion, blending or picture in picture operations of the captured images.

According to another embodiment, the first imaging system is an IR imaging system, whereby the first image is an IR image, and the second imaging system is a visible light imaging system, whereby the second image is a visible light image.

According to another embodiment, the first imaging system is a visible light imaging system whereby the first image is a visible light image and the second imaging system an IR imaging system whereby the second image is an IR image.

According to another embodiment, the first and the second imaging systems are two different IR imaging systems and the first and second images are IR images captured using the first and second IR imaging system respectively.

According to another embodiment, the first and the second imaging systems are two different visible light imaging systems and the first and the second images are visible light images captured using first and second visible light imaging system respectively.

In one or more embodiments, the pre-determined image distortion relationship represents a difference in image distortion between an IR imaging system and a visible light imaging system, both comprised in an IR arrangement 1. According to this embodiment, using said image distortion relationship to correct image distortion of said captured one or more images may comprise a selection of the following:
correcting an IR image captured using the IR imaging system with relation to a visible light image captured using the visible light imaging system, based on the pre-determined image distortion relationship;
correcting a visible light image captured using the visible light imaging system with relation to an IR image captured using the IR imaging system, based on the pre-determined image distortion relationship; or
processing both an IR image captured using the IR imaging system and a visible light image captured using the visible light imaging system based on the pre-determined image distortion relationship, so that the processed images are image distortion corrected with relation to each other.

In FIG. 2a, a distorted image 200 and corresponding image 210 after distortion correction are shown. The distorted image 200 shows a type of image distortion known as barrel distortion, one of several types of image distortions known to a person skilled in the art. A few examples of other distortion types are pincushion distortion and mustache or complex distortion.

According to embodiment, distortion correction of image 200 into image 210 may be performed in real time by use of a pre-determined distortion relationship in the form of a map or look-up table (LUT). According to this implementation, different types of distortion behavior may be corrected without any reprogramming or introduction of new algorithms or code into the FPGA or other general processing unit performing the distortion correction.

According to other embodiments, distortion correction of image 200 into image 210 may be performed in real time by use of a pre-determined distortion relationship in the form of a pre-determined function, such as a transfer function, an equation, an algorithm or other set of parameters and rules describing the distortion relationship as would be understood by a person skilled in the art.

In one or more embodiments, the pre-determined distortion relationship may be determined by calculation, wherein the calculation comprises evaluating the pre-determined function and storing the result to memory 15.

According to embodiments, the pre-determined distortion relationship, related to distortion caused by the imaging systems used for capturing images, may have been determined during production calibration, service calibration, input by a user using control component 3 described in connection with FIG. 1, or determined using a self-calibration function of the IR arrangement or IR camera.

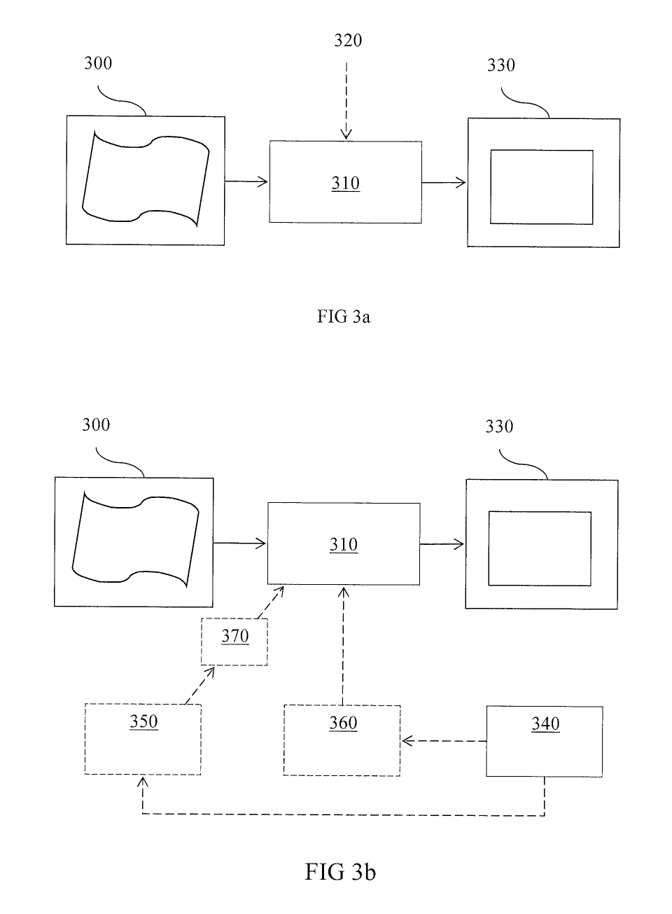

In FIGS. 3a and 3b, flow diagrams of distortion correction methods according to embodiments are shown. In FIGS. 3a and 3b, a distorted mage 300 is processed in a step 310 into a corrected image 330.

According to an embodiment, a processing unit 2, or an external processing unit communicatively coupled to the IR arrangement 1, is adapted to process the image 300 according to the method embodiments of FIG. 3a.

An embodiment is depicted in FIG. 3b, wherein the distortion correction functionality needed to perform distortion correction according to embodiments is implemented in a step 340.

In one or more embodiments, step 340 is typically performed once, for example in production calibration or upgrading of the IR arrangement, IR camera or post-processing unit used for the distortion correction.

Thereafter, according to embodiments, distortion correction may be performed by mapping of pixel coordinates, based on a distortion relationship in the form of a distortion map or LUT 360 that indicates a one-to-one relationship between the pixel coordinates of the input image 300 and the pixel coordinates of the corrected output image 330.

In one or more embodiments, the distortion map or LUT 360 may be stored in the memory 15, the memory of the processing unit performing the distortion correction, or an external memory accessible by the processing unit performing the distortion correction.

Embodiments including the distortion map, or LUT, 360 require memory space, but include a low computational cost for the processing unit performing the coordinate mapping in step 310. Therefore, the mapping of step 310 may according to embodiments be performed at the frame rate of the imaging system or systems capturing the image, for example at a frame rate of 30 Hz.

### Reduced Calculation Complexity

According to an exemplary embodiment, the distortion map or LUT may represent distortion mapping for a down-sampled version of a captured image, for example relating to a 32×24 pixel image instead of a 320×240 pixel image. According to this exemplary embodiment, the memory storing the distortion map or LUT has to be accessed just a small fraction of the times needed for the case wherein the map or LUT represents all the pixels of the captured image, thereby rending large computational savings. FIG. 3b depicts an embodiment, wherein the down-sampled map or LUT embodiment is illustrated by 350 and 370, wherein 350 illustrates the down-sampled map or LUT and step 370 comprises up-sampling of the map or LUT before the processing performed in step 310. A down-sampled map or LUT may for instance advantageously be used when the distortion to be corrected is a low spatial frequency defect, such as for example a rotational defect.

According to embodiments, all distortion correction methods may include interpolation of pixel values for at least a subset of the pixels in an image that are to be “replaced” in order to obtain a corrected image. Any suitable type of interpolation known in the art may be used, for instance nearest neighbor interpolation, linear interpolation, bilinear interpolation, spline interpolation or polynomial interpolation. According to an embodiment, weighted interpolation may be used.

In one or more embodiments, the processing 310 comprises processing the image 300 based on a known or pre-determined distortion relationship, for example determined during production or calibration of the IR arrangement. The known distortion relationship may for instance be expressed in the form of a function, a transfer function, an equation, an algorithm, a map, a look up table (LUT) or another set of parameters and rules.

According to an embodiment, one or more parameters and/or rules 320 are used for the processing of step 310. According to embodiments, the one or more parameters and/or rules may be default parameters determined during design of the IR arrangement, or parameters and/or rules determined during production calibration, self-calibration, use or service calibration relating to the individual spread of distortion, for example relating to the center of distortion, rotational distortion and/or translational distortion, due to the mechanical tolerances of the specific IR arrangement.

The one or more parameters 320 may according to embodiments relate to the pre-determined distortion relationship that may for instance be expressed in the form of a function, a transfer function, an equation, an algorithm, a map, a look up table (LUT) or another set of parameters and rules.

According to an embodiment, the parameters and/or rules 320 are stored in the memory 15, or an external memory unit accessible to the processing unit performing the image processing in step 310. According to this embodiment, the processing unit performing the image processing in step 310 is configured to receive or retrieve said one or more parameters and/or rules from an accessible memory unit in which they are stored. According to embodiments, the processing of step 310 may for example be performed in an FPGA or a general processing unit.

According to an embodiment, the processing 310 described in FIG. 3a is performed for each frame in an image frame sequence. As is readily understood by a person skilled in the art, processing may be performed less frequently dependent on circumstances such as performance or computational capacity of the IR arrangement, and/or bandwidth available for transfer of images. According to embodiments wherein the processing of step 310 is performed for a selected subset of all frames, or in other words a down-sampled set of the sequence of captured image frames, interpolation is used to generate intermediate distortion corrected image frames. According to another embodiment, interpolation of distortion corrected images may be used if the imaging system used for capturing images has a low frame rate.

According to other embodiments, the processing of step 310 is performed for a subset of all pixels in an image frame, or in other words a down-sampled image frame. According to these embodiments, pixel interpolation is used.

Typically, IR images have a lower resolution than visible light images and calculation of distortion corrected pixel values is hence less computationally expensive than for visible light images. Therefore, it may be advantageous to distortion correct IR images with respect to visible light images. However, depending on the imaging systems used, the opposite may be true for some embodiments. Furthermore, since IR images are typically more “blurry”, or in other words comprise less contrast in the form of contour and outlines for example, than visible light images, down-sampling and use of interpolated values may be used for IR images without any visible degradation occurring.

Any suitable interpolation method known in the art may be used for the interpolation according to embodiments of the invention, dependent on, for instance, whether the focus is on quality or computational cost.

In one or more embodiments, the image that is being corrected may be an IR image or a visual light image.

In one or more embodiments, the distortion correction may refer to correcting an IR image, a visual light or both to correspond to the observed scene captured in the images or to correcting images to be “perfect” or to as great an extent as possible resemble an external reference such as the depicted scene or a reference image.

In one or more embodiments, the distortion correction may refer to correcting an IR image to resemble a visual light image depicting the same scene, correcting the visual light image to resemble the IR image, or correcting/processing both the IR image and the visual light image so that they resemble each other. Accordingly, the pre-determined distortion relationship may describe a distortion caused by a first imaging system, that may for example be an IR imaging system or a visual light imaging system, a distortion caused by the second imaging system that may for example be an IR imaging system or a visual light imaging system, or a distortion relationship between the first imaging system and the second imaging system.

A specific problem that arises in IR imaging involving combination, for example fusion, of images captured using different imaging systems, for example an IR imaging system and a visible light imaging system, is that the images must be aligned in order for the combination result to be satisfying for visual interpretation and measurement correlation.

### Advantage of Correction of a First Image in Relation to a Second Image.

The inventors have realized that by reducing the computational complexity by leaving out the step of performing distortion correction with respect to the imaged scene or an external reference, and instead performing distortion correction of the images in relation to each other according to the different embodiments presented herein, the distortion correction can be performed in a much more resource efficient way, with satisfying output quality.

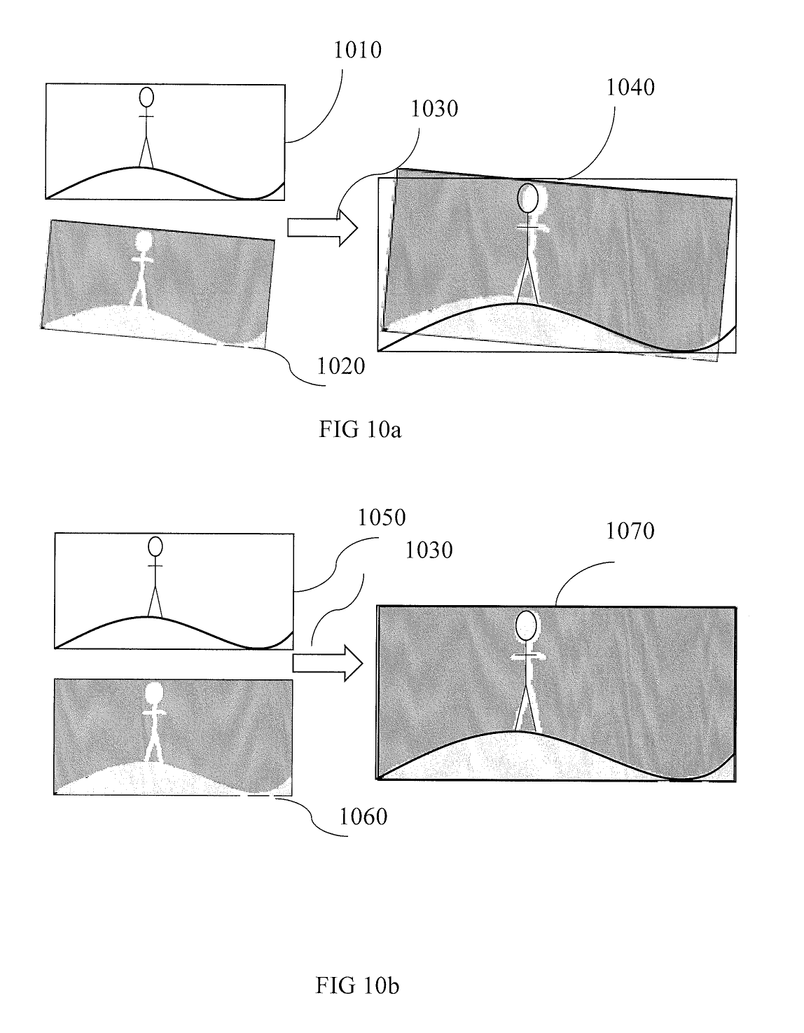

FIG. 10a shows an exemplary embodiment of a method of combining a first distorted image and a second distorted image without distortion correction. In this particular embodiment a contrast enhanced combined image 1040 is generated 1030 from a VL image 1010 and an IR image 1020. As can be seen from FIG. 10a contours of the objects do not align well.

FIG. 10b shows an exemplary embodiment of a method of combining a first distorted image and a second distorted image with distortion correction functionality. In this particular embodiment a contrast enhanced combined image 1070 is generated 1030 from a VL image 1050 and an IR image 1060. As can be seen from FIG. 10b aligning of contours of the objects is improved rendering sharper images with enhanced contrast. In an exemplary embodiment the combined image is a contrast enhanced version of an IR image with addition of VL image data, which are combined after distortion correction thereby obtaining an improved contrast enhanced combined image.

Therefore, according to embodiments, the distortion correction does not need to be as correct as possible with regard to a real world scene or another external reference. The main idea is instead that the geometrical representation of the images from the respective imaging systems will resemble each other as much as possible or that the images will be as well aligned as possible, after the correction.

Aiming to Make Two Images Resemble Each Other and/or to be Better Aligned

In one or more embodiments, distortion to one of the images is added instead of reducing it in the other, for example in applications of the inventive concept in cases where this is the more computationally efficient solution.

Thereby, for example FPGA implementation of distortion correction and/or real time image distortion correction and fusing of distortion corrected images is enabled. A further advantageous effect achieved by embodiments of the invention is that an improved alignment of images to be combined is achieved, thereby also rendering sharper images after combination.

Method embodiments presented herein may be used for aligning images captured using different imaging systems, for example when the images are to be combined through fusion or other combination methods, since the method embodiments provide images that are distortion corrected and thereby better aligned with respect to each other and/or with respect to the depicted scene.

In one or more embodiments, a distortion relationship between a first imaging system and a second imaging system may be in the form of a reference showing an intermediate version of the distortion caused by the first imaging system and the second imaging system, to which images captured using both imaging systems are to be matched or adapted. Of course, any type of images captured using different imaging systems, for instance IR images captured using different IR imaging systems or visible light images captured using different visible light imaging systems, may be corrected with respect to the depicted scene and/or to each other using the method embodiments described herein.

In an exemplary embodiment, IR images captured using an IR imaging sensor may be corrected to match visible light images captured using a visible light imaging sensor, visible light images captured using a visible light imaging sensor may be corrected to match IR images captured using an IR imaging sensor, or both IR images captured using an IR imaging sensor and visible light images captured using a visible light imaging sensor may be partly corrected to match each other. Thereby, distortion corrected images that match each other as much as possible are obtained.

### Projector Alignment

According to embodiments, an IR image or a visible light image, captured using an IR imaging system or a visible light imaging system respectively, may be distortion corrected with respect to the image projected by an imaging system in the form of a projector, for example a visible light projector projecting visible light onto the scene that is being observed and/or depicted. As in the embodiments above, a captured image may be distortion corrected with respect to the projector image, a projector image may be corrected with respect to a captured image, or both images may be partly corrected with respect to each other. According to all these embodiments, the captured images will be better aligned with the projection of the projector.

According to different embodiments, the aim is to achieve resemblance between an image and the imaged scene or an external reference, or resemblance between two images. If resemblance between images is the aim, this may mean that, but does not necessarily have to mean that, the images look correct compared to the observed real world scene that is depicted. More importantly, by providing for example an IR image and a visual light image that are distortion corrected with regard to each other, the distortion corrected images are well aligned and a good visual result will be achieved if the images are combined, for example if they are fused, blended or combined using a picture in picture technique. Thereby a user is enabled to analyze and interpret what is displayed in the combined image, even if the combined image is still more or less distorted compared to the depicted real world scene. Furthermore, distortion correction that is computationally inexpensive is achieved, since it does not have to be as exact as when an image is adapted to match a real world scene or other, “perfect,” external reference. This means that for example FPGA implementation of distortion correction and/or real time image distortion correction and fusing of distortion corrected images according to embodiments of the invention is enabled.

In order to satisfy the operational constraints imposed by real-time processing the algorithm may according to embodiments be implemented in hardware, for example in an FPGA. However, according to embodiments, the processing unit 2, or an external processing unit, according to any of the alternative embodiments presented in connection with the arrangement of FIG. 1, may be used for performing any or all of the method steps or functions described herein.

Rotation and/or Translation Distortion (Parallax Error)

According to embodiments, the processing unit used for distortion correction is configured to compensate distortions in the form of rotation and/or translation. In one or more embodiments, wherein two images, such as the first and the second image, are captured using two different imaging systems and distortion corrected with respect to each other, rotational and translational distortion that is compensated for may describe the difference in parallax rotation error, parallax distance error and parallax pointing error between the two imaging systems.

According to an embodiment, parallax error compensation between the two imaging systems for parallax rotation error, corresponding to a certain number of degrees rotation difference around each imaging systems optical axis, and/or translation, represented as displacement in the x and y direction due to parallax distance error and parallax pointing error, may be compensated for in a distortion relationship, e.g. added to a pre-determined distortion relationship in the form of a pre-determined distortion map, LUT, function, transfer function, algorithm or other set of parameters and rules that form the pre-determined distortion relationship.

Rotation and/or translation are important factors to take into consideration for the embodiments wherein combination of images, such as fusion, blending or picture in picture, is to be performed. Since rotational errors and/or translational errors are constant during the life of an imaging device, these errors may be determined during production or calibration of the IR arrangement 1. According to an embodiment, rotational and/or translational distortion may be input by a user using control component 3 described in connection with FIG. 1.

In FIG. 2b, a distorted image 220 and corresponding image 230 after distortion correction are shown. The distorted image 220 shows an image into which a rotational distortion of the angle α has been introduced. According to embodiments not shown in the figure, the image could instead, or in addition, be distorted by translational distortion. As illustrated in FIG. 2b by the dotted outline, the distortion correction method may according to an embodiment comprise cropping the corrected image and scaling the cropped out portion to match the size and/or resolution of the area 240. The area 240 may correspond to the display unit, or a selected part of the display unit, onto which the corrected image 230 is to be displayed. In order to scale the image to fit a different resolution, any suitable kind of interpolation known in the art may be used.

According to embodiment, the distortion correction of image 220 into image 230 may be performed in real time by use of a pre-determined distortion map or look-up table (LUT). According to this implementation, different types of distortion behavior may be corrected without any reprogramming or introduction of new algorithms or code into the FPGA or other general processing unit performing the distortion correction.

According to other embodiments, the distortion correction of image 220 into image 230 may be performed in real time by use of a pre-determined function, transfer function, equation, algorithm or other set of parameters and rules describing the distortion relationship.

According to embodiments, the pre-determined distortion, caused by the imaging systems used for capturing images, may have been determined during production calibration, service calibration, input by a user using control component 3 described in connection with FIG. 1, or determined using a self-calibration function of the IR arrangement or IR camera.

According to an embodiment, rotation and/or translation compensation is integrated in the pre-determined distortion relationship. Thereby, a combined rotation, translation and distortion correction may be achieved during runtime, based on the predetermined relationship.

As is readily apparent to a person skilled in the art, any kind of image distortion caused by the imaging system used to capture an image that leads to displacement of pixels within a captured image may be corrected using embodiments presented herein.

According to an embodiment, methods presented herein may further be used to change the field of view of an image, for example rendering a smaller field of view as illustrated in FIG. 2b. By scaling such a changed field of view a zoom-in effect, or a zoom-out effect, may be obtained. Furthermore, according to the embodiments wherein two images captured using different imaging systems are to be combined through for example fusion, blending or picture in picture, the field of view of one or both images may be adjusted before combination of the images to obtain a better match or alignment of the images.

Combined Images with Contrast Enhancement

According to an embodiment, enabling the user to access the associated images for display further comprises enabling display of a combined image dependent on the associated images.

According to an embodiment, the combined image is a contrast enhanced version of the IR image with addition of VL image data.

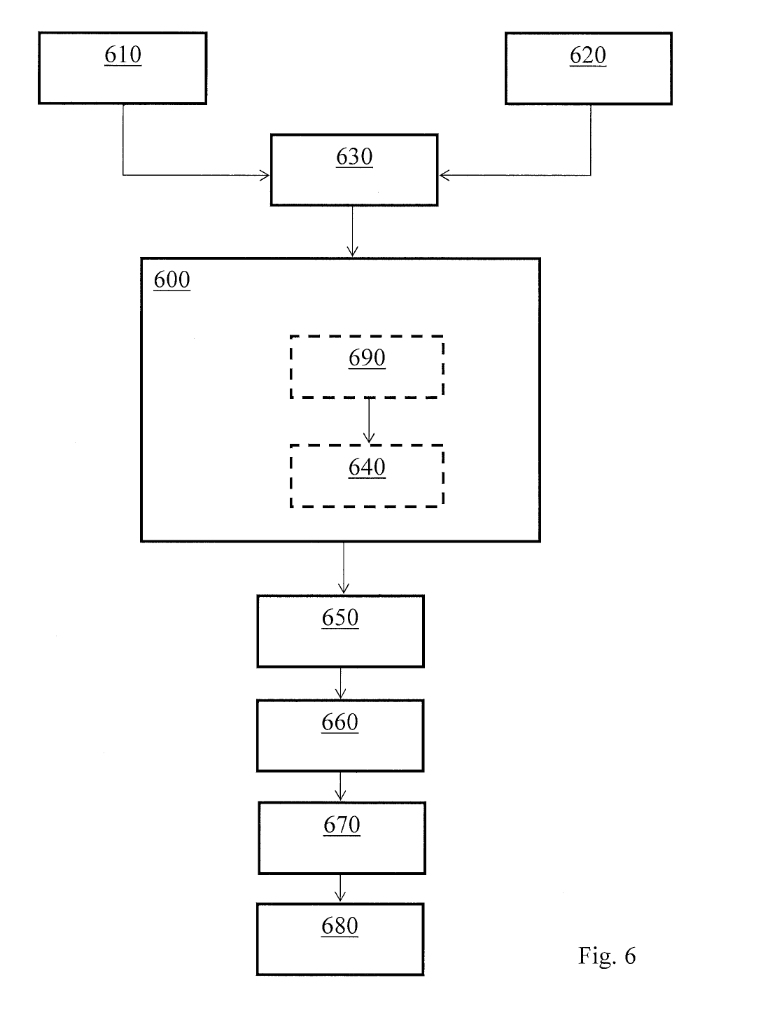

According to an embodiment, a method for obtaining a combined image comprises the steps of aligning, determining that the VL image resolution value and the IR image resolution value are substantially the same and combining the IR image and the VL image. A flow diagram of the method is shown in FIG. 6 in accordance with an embodiment of the disclosure.

### Capturing

In one or more embodiments, a thermography arrangement or imaging device in the form of an IR camera is provided with a visual light (VL) imaging system to capture a VL image, an infrared (IR) imaging system to capture an IR image, a processor adapted to process the captured IR image and the captured VL image so that they can be displayed on a display on the thermography arrangement together as a combined image. The combination is advantageous in identifying variations in temperature in an object using IR data from the IR image while at the same time displaying enough data from the VL image to simplify orientation and recognition of objects in the resulting image for a user using the imaging device.

Within the area of image processing, an IR image depicting a real world scene comprising one or more objects can be enhanced by combination with image information from a VL image depicting said real world scene, said combination being known as fusion.

In one embodiment an IR image depicting a real world scene comprising one or more objects is enhanced by combining it with image information from a VL image depicting said real world scene such that contrast is enhanced. The inventive concept is described below.

### Aligning

Since the capturing of the infrared (IR) image and capturing of the visual light (VL) image is generally performed by different imaging systems of the imaging device mounted in a way that the offset, direction and rotation around the optical axes differ. The optical axes between the imaging systems may be at a distance from each other and an optical phenomenon known as parallax distance error will arise. The optical axes between the imaging systems may be oriented at an angle in relation to each other and an optical phenomenon known as parallax pointing error will arise. The rotation of the imaging systems around their corresponding optical axes and an optical phenomenon known as parallax rotation error will arise. Due to these parallax errors the captured view of the real world scene, called field of view (FOV) might differ between the IR imaging system and the VL imaging system.

Since the capturing of the infrared (IR) image and capturing of the visual light (VL) image is generally performed by different imaging systems of the imaging device with different optical systems with different properties, such as magnification, the captured view of the real world scene, called field of view (FOV) might differ between the imaging systems. The IR image and the VL image might be obtained with different optical systems with different optical properties, such as magnification, resulting in different sizes of the FOV captured by the IR sensor and the VL sensor.

In order to combine the captured IR and captured VL image the images must be adapted so that an adapted IR image and adapted VL image representing the same part of the observed real world scene is obtained, in other words compensating for the different parallax errors and FOV size. This processing step is referred to as registration of or alignment of the IR image and the VL image. Registration or alignment can be performed according to an appropriate technique as would be understood by a skilled person in the art.

Determining that the VL Image Resolution Value and the IR Image Resolution Value are Substantially the Same

In an embodiment the IR image and the VL image might be obtained with different resolution, i.e. different number of sensor elements of the imaging systems. In order to enable pixel wise operation on the IR and VL image they need to be re-sampled to a common resolution. Re-sampling can be performed according to any method known to a skilled person in the art.

In an embodiment the IR image is resampled to a first resolution and the VL image are resampled to a second resolution, wherein the first resolution is a multiple of 2 times the second resolution or the second resolution is a multiple of 2 times the first resolution, thereby enabling instant resampling by considering every 2^{N} pixels of the IR image or the VL image.

### Combining IR Image and VL Image

In one or more embodiments an IR image and a VL image is combined by combining an aligned IR image with high spatial frequency content of an aligned VL image to yield a contrast enhanced combined image. The combination is performed through superimposition of the high spatial frequency content of the VL image and the IR image, or alternatively superimposing the IR image on the high spatial frequency content of the VL image. As a result, contrasts from the VL image can be inserted into an IR image showing temperature variations, thereby combining the advantages of the two image types without losing clarity and interpretability of the resulting combined image.

According to an embodiment, a method for obtaining a contrast enhanced combined image comprises the following steps:

### Step 610: Capturing VL Image.

In an exemplary embodiment, capturing a VL image comprises capturing a VL image depicting the observed real world scene using the VL imaging system with an optical system and sensor elements, wherein the captured VL image comprises VL pixels of a visual representation of captured visual light image. Capturing a VL image can be performed according to any method known to a skilled person in the art.

### Step 620: Capturing an IR Image.

In an exemplary embodiment, capturing an IR image comprises capturing an IR image depicting an observed real world scene using the IR imaging system with an optical system and sensor elements, wherein the captured IR image comprises captured infrared data values of IR radiation emitted from the observed real world scene and associated IR pixels of a visual representation representing temperature values of the captured infrared data values. Capturing an IR image can be performed according to any method known to a skilled person in the art.

In an exemplary embodiment, steps 610 and 620 are performed simultaneously or one after the other. In an exemplary embodiment, the images may be captured at the same time or with as little time difference as possible, since this will decrease the risk for alignment differences due to movements of an imaging device unit capturing the visual and IR images. As is readily apparent to a person skilled in the art, images captured at time instances further apart may also be used.

In an exemplary embodiment, the sensor elements of the IR imaging system and the sensor elements of the VL image system are substantially the same, e.g. have substantially the same resolution.

In an exemplary embodiment, the IR image may be captured with a very low resolution IR imaging device, the resolution for instance being as low as 64×64 or 32×32 pixels, but many other resolutions are equally applicable, as is readably understood by a person skilled in the art. The inventors have found that if edge and contour (high spatial frequency) information is added to the combined image from the VL image, the use of a very low resolution IR image will still render a combined image where the user can clearly distinguish the depicted objects and the temperature or other IR information related to them. Capturing an IR image can be performed according to any method known to a skilled person in the art.

### Step 630: Aligning the IR Image and the VL Image.

In an exemplary embodiment, parallax error comprises parallax distance error between the optical axes that generally arises due to differences in placement of the sensors of the imaging systems for capturing said IR image and said VL image, the parallax pointing error angle created between these axes due to mechanical tolerances that generally prevents them being mounted exactly parallel and the parallax rotation error due to mechanical tolerances that generally prevents them being mounted exactly with the same rotation around the optical axis of the IR and VL image systems.

In an exemplary embodiment, the capturing of the infrared (IR) image and capturing of the visual light (VL) image is performed by different imaging systems of the imaging device with different optical systems with different properties, such as magnification, the extent of the captured view of the real world scene, called size of field of view (FOV) might differ.

Aligning the IR image by compensating for parallax error and size of FOV to obtain an aligned IR image and an aligned VL image with substantially the same FOV can be performed according to any method known to a skilled person in the art.

Step 690: determining a resolution value of the IR imaging system and a resolution value of VL imaging system, wherein the resolution value of the IR imaging system corresponds to the resolution of the captured IR image and the resolution value of VL imaging system corresponds to the resolution of the captured VL image.

In one exemplary embodiment, the resolution value represents the number of pixels in a row and the number of pixels in a column of a captured image. In one exemplary embodiment, the resolutions of the imaging systems are predetermined.

Determining a resolution value of the IR imaging system and a resolution value of VL imaging system, wherein the resolution value of the IR imaging system corresponds to the resolution of the captured IR image and the resolution value of VL imaging system corresponds to the resolution of the captured VL image can be performed according to any method known to a skilled person in the art.

Step 600: Determining that the VL Image Resolution Value and the IR Image Resolution Value are Substantially the Same.

If in Step 600 it is determined that the VL image resolution value and the IR image resolution value are not substantially the same, the method may further involve the optional step 640 of re-sampling at least one of the received images so that the resulting VL image resolution value and the resulting IR image resolution value, obtained after re-sampling, are substantially the same.

In one exemplary embodiment, re-sampling comprises up-sampling of the resolution of the IR image to the resolution of the VL image, determined in step 690. In one exemplary embodiment, re-sampling comprises up-sampling of the resolution of the VL image to the resolution of the IR image, determined in step 690. In one exemplary embodiment, re-sampling comprises down-sampling of the resolution of the IR image to the resolution of the VL image, determined in step 690. In one exemplary embodiment, re-sampling comprises down-sampling of the resolution of the VL image to the resolution of the IR image, determined in step 690.

In one exemplary embodiment, re-sampling comprises re-sampling of the resolution of the IR image and the resolution of the VL image to an intermediate resolution different from the captured IR image resolution and the captured VL image resolution determined in step 690.

In one exemplary embodiment, the intermediate resolution is determined based on the resolution of a display unit of the thermography arrangement or imaging device.

According to an exemplary embodiment, the method steps are performed for a portion of the IR image and a corresponding portion of the VL image. According to an embodiment, the corresponding portion of the VL image is the portion that depicts the same part of the observed real world scene as the portion of the IR image. In this embodiment, high spatial frequency content is extracted from the portion of the VL image, and the portion of the IR image is combined with the extracted high spatial frequency content of the portion of the VL image, to generate a combined image, wherein the contrast and/or resolution in the portion of the IR image is increased compared to the contrast of the originally captured IR image.

According to different embodiments, said portion of the IR image may be the entire IR image or a sub portion of the entire IR image and said corresponding portion of the VL image may be the entire VL image or a sub portion of the entire VL image. In other words, according to an embodiment the portions are the entire IR image and a corresponding portion of the VL image that may be the entire VL image or a subpart of the VL image if the respective IR and visual imaging systems have different fields of view.

Determining that the VL image resolution value and the IR image resolution value are substantially the same can be performed according to any method known to a skilled person in the art.

### Step 650: Process the VL Image by Extracting the High Spatial Frequency Content of the VL Image.

According to an exemplary embodiment, extracting the high spatial frequency content of the VL image is performed by high pass filtering the VL image using a spatial filter.

According to an exemplary embodiment, extracting the high spatial frequency content of the VL image is performed by extracting the difference (commonly referred to as a difference image) between two images depicting the same scene, where a first image is captured at one time instance and a second image is captured at a second time instance, preferably close in time to the first time instance. The two images may typically be two consecutive image frames in an image frame sequence. High spatial frequency content, representing edges and contours of the objects in the scene, will appear in the difference image unless the imaged scene is perfectly unchanged from the first time instance to the second, and the imaging sensor has been kept perfectly still. The scene may for example have changed from one frame to the next due to changes in light in the imaged scene or movements of depicted objects. Also, in almost every case the imaging device or thermography system will not have been kept perfectly still.

A high pass filtering is performed for the purpose of extracting high spatial frequency content in the image, in other words locating contrast areas, i.e. areas where values of adjacent pixels display large differences, such as sharp edges. A resulting high pass filtered image can be achieved by subtracting a low pass filtered image from the original image, calculated pixel by pixel.

Processing the VL image by extracting the high spatial frequency content of the VL image can be performed according to any method known to a skilled person in the art.

Step 660: process the IR image to reduce noise in and/or blur the IR image. Step 660 may be optional.

According to an exemplary embodiment, processing the IR image comprises reducing noise and/or blur the IR image is performed through the use of a spatial low pass filter. Low pass filtering may be performed by placing a spatial core over each pixel of the image and calculating a new value for said pixel by using values in adjacent pixels and coefficients of said spatial core.

The purpose of the low pass filtering performed at optional step 660 is to smooth out unevenness in the IR image from noise present in the original IR image captured at step 620. Since sharp edges and noise visible in the original IR image are removed or at least diminished in the filtering process, the visibility in the resulting image is further improved through the filtering of the IR image and the risk of double edges showing up in a combined image where the IR image and the VL image are not aligned is reduced.

Processing the IR image to reduce noise in and/or blur the IR image can be performed according to any method known to a skilled person in the art.

### Step 670: Combining the Extracted High Spatial Frequency Content of the Captured VL Image and the Optionally Processed IR Image to a Combined Image.

In one exemplary embodiment, combining the extracted high spatial frequency content of the captured VL image and the optionally processed IR image to a combined image comprises using only the luminance component Y from the processed VL image.

In one exemplary embodiment, combining the extracted high spatial frequency content of the captured VL image and the optionally processed IR image to a combined image comprises combining the luminance component of the extracted high spatial frequency content of the captured VL image with the luminance component of the optionally processed IR image. As a result, the colors or greyscale of the IR image are not altered and the properties of the original IR palette maintained, while at the same time adding the desired contrasts to the combined image. To maintain the IR palette through all stages of processing and display is beneficial, since the radiometry or other relevant IR information may be kept throughout the process and the interpretation of the combined image may thereby be facilitated for the user.

In one exemplary embodiment, combining the extracted high spatial frequency content of the captured VL image and the optionally processed IR image to a combined image comprises combining the luminance component of the VL image with the luminance component of the IR image using a factor alpha to determine the balance between the luminance components of the two images when adding the luminance components. This factor alpha can be determined by the imaging device or imaging system itself, using suitable parameters for determining the level of contour needed from the VL image to create a satisfactory image, but can also be decided by a user by giving an input to the imaging device or imaging system. The factor can also be altered at a later stage, such as when images are stored in the system or in a PC or the like and can be adjusted to suit any demands from the user.

In one exemplary embodiment, combining the extracted high spatial frequency content of the captured VL image and the optionally processed IR image to a combined image comprises using a palette to map colors to the temperature values of the IR image, for instance according to the YCbCr family of color spaces, where the Y component (i.e. the palette luminance component) may be chosen as a constant over the entire palette. In one example, the Y component may be selected to be 0.5 times the maximum luminance of the combined image, the VL image or the IR image. As a result, when combining the IR image according to the chosen palette with the VL image, the Y component of the processed VL image can be added to the processed IR image 305 and yield the desired contrast without the colors of the processed IR image being altered. The significance of a particular nuance of color is thereby maintained during the processing of the original IR image.

When calculating the color components, the following equations can be used to determine the components Y, Cr and Cb for the combined image with the Y component from the processed, e.g. high pass filtered, VL image and the Cr and Cb components from the IR image

hp_{—}y_{—}vis=highpass(y_{—}vis)

(y_{—}ir,cb_{—}ir,cb_{—}ir)=colored(lowpass(ir_signal_linear))

which in another notation would be written as:

hp_{y}_{ᵥᵢₛ}=highpass(yᵥᵢₛ)

(yᵢᵣ,crᵢᵣ,cbᵢᵣ)=colored(lowpass(ir_{signal linear}))

Other color spaces than YCbCr can, of course, also be used with embodiments of the present disclosure. The use of different color spaces, such as RGB, YCbCr, HSV, CIE 1931 XYZ or CIELab for instance, as well as transformation between color spaces is well known to a person skilled in the art. For instance, when using the RGB color model, the luminance can be calculated as the mean of all color components, and by transforming equations calculating a luminance from one color space to another, a new expression for determining a luminance will be determined for each color space.

### Step 680: Adding High Resolution Noise to the Combined Image.

According to an exemplary embodiment, the high resolution noise is high resolution temporal noise. High resolution noise may be added to the combined image in order to render the resulting image more clearly to the viewer and to decrease the impression of smudges or the like that may be present due to noise in the original IR image that has been preserved during the optional low pass filtering of said IR image.

According to an embodiment, the processor 2 is arranged to perform the method steps 610-680. There may be provided a user interface enabling the user to interact with the displayed data, e.g. on display 4. Such a user interface may comprise selectable options or input possibilities allowing a user to switch between different views, zoom in on areas of interest etc. In order to interact with the display, the user may provide input using one or more of the input devices of control component 3.

### Distortion Correction Map or Lookup Table

According to an embodiment, the pre-determined distortion relationship is a distortion map describing the distortion caused by the different imaging systems may be pre-determined and used for distortion correction at runtime.

According to other method embodiments, distortion relationship values are pre-determined and placed in a look-up-table (LUT). By using the LUT and interpolation of pixel values, the complexity of the hardware design may be reduced without significant loss of precision compared to calculating values at run-time.

The distortion relationship describes the distortion of one imaging system compared to depicted scene or compared to an external reference distortion, or the distortion of two imaging systems compared to each other. According to embodiments, the distortion relationship may be determined during production calibration, service calibration or self-calibration of the IR arrangement in which the imaging system or systems in question are integrated, or which said systems are communicatively coupled to or configured to transfer image data to and/or from. According to an embodiment, the distortion relationship may be input or changed by a user using control component 3.

The distortion relationship may be used during operation of an IR arrangement for correction with respect to scene, external reference or between the different imaging systems used. As previously mentioned, distortion correction according to embodiments may refer to correcting images captured by one imaging system compared to images captured by another imaging system to resemble each other or to correct/process images from one or more imaging systems to resemble a depicted scene or external reference.

According to embodiments, the distortion relationship may be stored in memory 15, or in another internal memory or external memory accessible to the processing unit 2 of the IR arrangement 1 during operation, or accessible to an external processing unit in post-processing.

### Coordinate Mapping

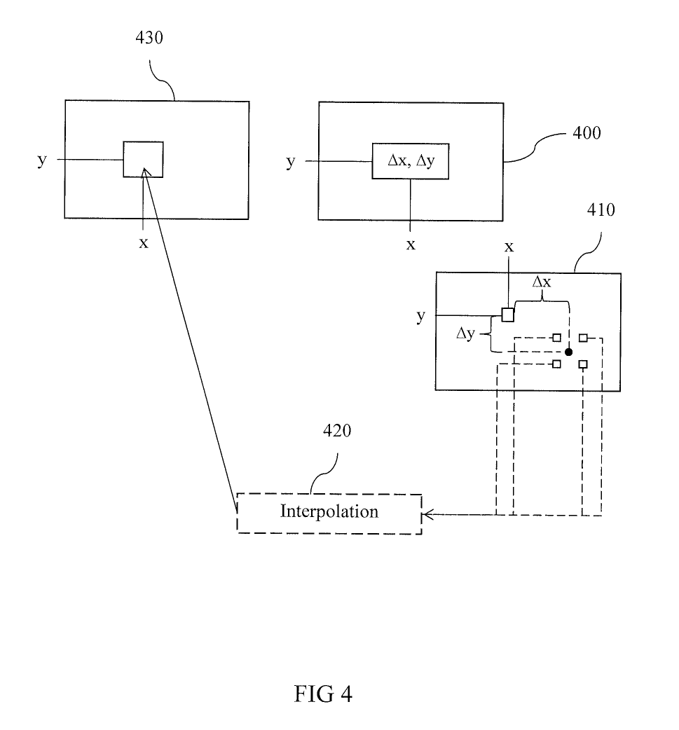

In FIG. 4, embodiments of distortion correction using a distortion map or LUT are illustrated.

In FIG. 4, a distortion map or LUT 400 is provided, wherein mapping of each pixel (x, y) in a captured image is for example represented as a displacement (Δx, Δy). According to embodiments, the preciseness of the displacement values, in terms of the number of decimals for instance, may be different for different application dependent on quality demands versus computational cost.

Displacement values (Δx, Δy) are obtained from the distortion relationship that is dependent on the optics of the imaging system or imaging systems involved. As mentioned herein, the distortion relationship may be determined during production calibration, self-calibration or service calibration of the one or more imaging devices involved.

According to an embodiment, the processing unit performing the distortion correction calculates the displacement value for each pixel during operation or post-processing, thereby generating a distortion map in real time, or during runtime. In other words, the distortion map is calculated for every pixel, or for a subpart of the pixels depending on circumstances. According to an embodiment, the processing unit performing the distortion correction is an FPGA. Calculations of the displacement values or distortion map values during runtime require frequent calculations, and thereby a larger computational block for the FPGA embodiment, but on the other hand the number of memory accesses required is reduced. One aspect to keep in mind is that if the equation for calculating the displacement values or distortion map values is changed, the FPGA implementation requires reprogramming of each FPGA, while the pre-defined distortion map or LUT embodiments instead only requires adaptation of the production code.

The computational effort required for the distortion correction, according to any of the embodiments presented herein, is increased in proportion to with the amount of distortion. For example, if the displacement values are large and distant pixels have to be “fetched” for distortion correction, the processing unit performing the distortion correction will have to have a larger number of pixels accessible in its memory at all times than if the displacement values are small.

The displacement values (Δx, Δy) are used to correct the pixel values of a distorted a captured image 410, representing the detector pixels, optionally via an interpolation step 420, into a distortion corrected image frame 430.

Displacement values having one or more decimals instead of being integer and/or the optional interpolation of step 420 may be used in order to reduce introduction of artifacts in the corrected image 430.

According to embodiments, all distortion correction methods may include interpolation 420 of pixel values for at least a subset of the pixels that are to be “replaced” in order to obtain a corrected image. Any suitable type of interpolation known in the art may be used, for instance nearest neighbor interpolation, linear interpolation, bilinear interpolation, spline interpolation or polynomial interpolation. According to an embodiment, weighted interpolation may be used.

### Distortion Correction Calculation in Real Time

According to embodiments, the distortion correction of the previous section may be performed by the use of real time calculations instead of mapping. According to these embodiments, a function, transfer function, algorithm or other set of parameters and rules is that describes the distortion relationship between the imaging system, or between one or more imaging systems and the scene or another external reference, is determined, for example during production or calibration. Thereby, calculation of the distortion correction may be performed in real time, for every captured image or image pair that is to be corrected for distortion. Compared to the embodiments wherein a distortion map or LUT is used, the real time computation methods require less memory capacity, but more logic in the processing unit performing the distortion correction. According to embodiments, the processing unit may be any type of processing unit described in connection with the arrangement of FIG. 1, for example a general type processor integrated in, connected to or external to the IR arrangement 1, or a specially configured processing unit, such as an FPGA. Just like the map described above, the distortion correction function or functions may be generated in design, production or calibration of the IR arrangement 1. According to embodiments, the distortion map or LUT is stored in the memory 15, a memory of an FPGA integrated in the IR arrangement or another memory unit connected to or accessible to the processing unit performing the distortion correction. During operation, the calculations of the distortion correction parameters and correction according to the calculated values may be performed by the processing unit 2 or an external processing unit communicatively coupled to the IR arrangement 1. According to an embodiment, the processing unit 2 is an FPGA and the calculation of distortion correction parameters as well, as the correction according to the calculated values, is performed by the FPGA.

### Applications of Use and Use Cases

Method embodiments presented herein may be used for fusion alignment; since the images captured using different imaging systems are distortion corrected with respect to each other and/or with respect to the depicted scene. Thereby, the images will resemble each other to a great extent. In other words, by providing an IR image and a visual light image that are distortion corrected with regard to each other, a good visual result will be achieved if the images are combined, for example if they are fused or blended. Thereby a user is enabled to analyze and interpret what is displayed in the combined image, even if the combined image is still more or less distorted compared to the depicted real world scene. Furthermore, distortion correction that is computationally inexpensive is achieved. Thereby, for example FPGA implementation of distortion correction and/or real time image distortion correction and fusing of distortion corrected images is enabled. According to embodiments, an operator may therefore for example use the distortion correction functionality in a handheld IR camera, comprising FPGA logic or any other suitable type of processing logic, and obtain distortion corrected and fused or blended images that are updated in real time, according to the frame rate of the IR camera.

Method embodiments presented herein may further be used for length or area measurement support on site. According to an exemplary application of use, an operator of an IR imaging system according to embodiments presented above may use the IR imaging system to investigate a construction surface in order to identify areas at risk of being moisture-damaged. If the operator finds such an area on the investigated surface, i.e. the operator can see on the display of the IR imaging device that an area is marked in a way that the operator knows represents a moist area, the operator may want to find out how large the area is. Therefore, the operator uses a measurement function included in the IR imaging system that calculates the actual length or area of the imaged scene, for example by calculations of the field of view taking into account and compensating for the distortion, scales the length or area to the size of the display, based on an obtained distance and/or field of view, and displays length and/or area units on the display. The operator can thereby see how large the identified area really is. The information, i.e. images, may also be stored for later retrieval and analysis. Since the IR imaging device comprises distortion correction, the length and/or area information will of course be more correct than if no correction had been performed. If no distortion correction had been performed, an area in the center of an image that is subject to barrel distortion would for example have appeared to be larger than it actually was, while an area in the periphery of the image would have appeared smaller than it was, compared to the length and/or area units displayed in the image.

By using distortion correction embodiments presented herein in combination with measurements of lengths or areas in the imaged scene, calculations and visualizations of information such as power/effect, for example in the form of watts per square meter (w/m²) may be presented in connection with displayed images or stored in connection with the captured images.

### FURTHER EMBODIMENTS

According to an embodiment, any or all the method steps or function described herein may be performed in post-processing of stored image data, for example using a PC or other suitable processing unit, provided that the processing unit has access to the pre-determined distortion relationship.

According to an embodiment, there is provided a computer system having a processing unit being configured to perform any of the steps or functions of any or all of the method embodiments disclosed herein.

According to an embodiment, there is provided a computer-readable medium on which is stored non-transitory information configured to control a processing unit to perform any of the steps or functions of any or all of the method embodiments disclosed herein.

According to an embodiment, there is provided a computer program product comprising code portions configured to control a processor to perform any of the steps or functions of any or all of the method embodiments disclosed herein.

According to an embodiment, there is provided a computer program product comprising configuration data adapted to configure a Field-programmable gate array (FPGA) to perform any of the steps or functions of any or all of the method embodiments disclosed herein.

According to an embodiment, there is provided a computer system having a processing unit being configured to perform any of the steps or functions of any or all of the method embodiments disclosed herein.

According to an embodiment, there is provided a computer-readable medium on which is stored non-transitory information configured to control a processing unit to perform any of the steps or functions of any or all of the method embodiments disclosed herein.

According to an embodiment, there is provided a computer program product comprising code portions configured to control a processing unit to perform any of the steps or functions of any or all of the method embodiments disclosed herein.

According to an embodiment, there is provided a computer program product comprising configuration data adapted to configure a Field-programmable gate array (FPGA) to perform any of the steps or functions of any or all of the method embodiments disclosed herein.

### Further Advantages

An advantageous effect obtained by embodiments described herein is that the optical systems for the IR arrangement or IR camera used can be made at a lower cost, since some distortion is allowed to occur. Typically, fewer lens elements can be used which greatly reduces the production cost. Even a single-lens solution would be possible. According to embodiments wherein the number of optical elements is reduced, high image quality is instead obtained through image processing according to embodiments described herein; either during operation of an IR arrangement or IR camera, or in post-processing of images captured using such an IR arrangement or IR camera. Thereby, further advantageous effects of embodiments disclosed herein are that the cost for optics included in the imaging systems, particularly IR imaging systems, may be reduced while the output image quality is maintained or enhanced, or alternatively that the image quality is enhanced without increase of the optics cost.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claim is:

1. A method of correcting distortion present in an image captured using an infrared (IR) arrangement, the method comprising:
capturing a first image using a first imaging system comprised in said IR arrangement; and
correcting image distortion of the first image based on a pre-determined distortion relationship.

2. The method of claim 1, wherein the first imaging system is an IR imaging system and the first image is an IR image captured using said IR imaging system.

3. The method of claim 1, wherein said distortion relationship represents distortion caused by said first imaging system of said IR arrangement.

4. The method of claim 1, further comprising capturing a second image using a second imaging system comprised in said IR arrangement, wherein:
said distortion relationship represents distortion caused by said first and/or second imaging systems of said IR arrangement; and
said correcting of image distortion of the first image comprises correcting image distortion with relation to the second image based on said pre-determined distortion relationship.

5. The method of claim 4, further comprising correcting image distortion of the second image with relation to the first image based on said pre-determined distortion relationship.

6. The method of claim 4, wherein:
the first imaging system is an IR imaging system, whereby the first image is an IR image, and the second imaging system is a visible light imaging system, whereby the second image is a visible light image;
the first imaging system is a visible light imaging system, whereby the first image is a visible light image and the second imaging system an IR imaging system whereby the second image is an IR image;
the first and the second imaging systems are two different IR imaging systems and the first and second images are IR images captured using the first and second IR imaging system respectively; or
the first and the second imaging systems are two different visible light imaging systems and the first and the second images are visible light images captured using first and second visible light imaging system respectively.

7. The method of claim 5, wherein the first imaging system is an IR imaging system, whereby the first image is an IR image and the second imaging system is a visible light imaging system whereby the second image is a visible light image.

8. The method of claim 5, wherein the first imaging system is a visible light imaging system, whereby the first image is a visible light image and the second imaging system an IR imaging system whereby the second image is an IR image.

9. The method of claim 5, wherein the first and the second imaging systems are two different IR imaging systems and the first and second images are IR images captured using the first and second IR imaging system respectively.

10. The method of claim 5, wherein the first and the second imaging systems are two different visible light imaging systems and the first and the second images are visible light images captured using first and second visible light imaging system respectively.

11. The method of claim 4, wherein said pre-determined distortion relationship is represented in the form of a distortion map or a look up table.

12. The method of claim 11, wherein the distortion map or look up table is based on one or more models for distortion behavior.

13. The method of claim 11, wherein said correction of distortion comprises mapping of coordinates in the x-direction and in the y-direction, respectively.

14. The method of claim 4, wherein the calculated distortion relationship is at least partly dependent on distortion in the form of rotational and/or translational deviations.

15. The method of claim 4, further comprising combining said first and second image into a combined image.

16. An infrared (IR) arrangement configured to capture an image and to correcting distortion present in said image, the arrangement comprising:
a first imaging system configured to capture an image;
a memory configured to store a pre-determined distortion function representing distortion caused by said first imaging system of said IR arrangement; and
a processing unit configured to receive or retrieve said pre-determined distortion relationship from said memory during operation of said IR arrangement, wherein the processing unit is further configured to use said pre-determined distortion relationship to correct distortion of said captured image during operation of the IR arrangement.

17. The infrared (IR) arrangement of claim 16, further comprising an IR camera and wherein one or more of the first imaging system, the memory and the processing unit are integrated into said IR camera.

18. The infrared (IR) arrangement of claim 16, wherein the first imaging system is an IR imaging system and the first image is an IR image captured using said IR imaging system.

19. The infrared (IR) arrangement of claim 16, wherein said distortion relationship represents distortion caused by said first imaging system of said IR arrangement.

20. The infrared (IR) arrangement of claim 16, further comprising a second imaging system configured to capture a second image, wherein:
said distortion relationship represents distortion caused by said first and/or second imaging systems of said IR arrangement; and
said processing unit is configured to correcting said image distortion of the first image by correcting image distortion with relation to the second image based on said pre-determined distortion relationship.

21. The infrared (IR) arrangement of claim 20, wherein said processing unit is further configured to correct image distortion of the second image with relation to the first image based on said pre-determined distortion relationship.

22. The infrared (IR) arrangement of claim 16, wherein the processing unit is configurable using a hardware description language (HDL).

23. The infrared (IR) arrangement of claim 21, wherein the processing unit is a Field-programmable gate array (FPGA).

24. A computer system having a processor being adapted to perform the method of claim 1.

25. A non-transitory computer-readable medium on which is stored non-transitory information adapted to control a processor to perform the method of claim 1.
